(19) United States
(12) Patent Application Publication
(10) Pub. No.: US 2026/0040212 A1
(43) Pub. Date: Feb. 5, 2026

(54) DISCONTINUOUS COVERAGE-RELATED POWER SAVING

(71) Applicant: APPLE INC., Cupertino, CA (US)

(72) Inventors: Vivek G. Gupta, San Jose, CA (US); Sridhar Prakasam, Fremont, CA (US); Haijing Hu, Los Gatos, CA (US); Anikethan Ramakrishna Vijaya Kumar, Mysuru (IN); Nirlesh Koshta, Bangalore (IN)

(73) Assignee: APPLE INC., Cupertino, CA (US)

(21) Appl. No.: 18/995,088

(22) PCT Filed: Jul. 13, 2023
(86) PCT No.: PCT/US2023/027598

§ 371 Date: Jan. 15, 2025

(30) Foreign Application Priority Data
Jul. 22, 2022 (IN) 202241042120

(51) Int. Cl. H04W 52/02; H04B 7/185

(52) U.S. Cl. CPC H04W 52/0216; H04B 7/18513

(57) ABSTRACT

The present application relates to devices and components including apparatus, systems, and methods that support discontinuous network coverage. In an example, a device can predict whether a network coverage is available thereto based on path information. The path information indicates a relative path between the device and a base station of the network. If the network coverage is available, the device can establish communications with the network (e.g., via NAS signaling). Otherwise, the device can forgo communications with the network (e.g., by disabling its AS layer).

### CROSS-REFERENCE TO RELATED APPLICATION

This PCT application claims priority to Indian Patent Application number 202241042120, filed on Jul. 22, 2022, entitled “DISCONTINUOUS COVERAGE-RELATED POWER SAVING,” the disclosure of which is herein incorporated by reference in its entirety for all purposes.

### FIELD OF INVENTION

Cellular communications can be defined in various standards to enable communications between a user equipment and a cellular network. For example, Fifth generation mobile network (5G) is a wireless standard that aims to improve upon data transmission speed, reliability, availability, and more. Cellular coverage is a relevant feature for data transmission. In particular, when a user equipment (UE) is within a cell coverage, the UE may be able to exchange data with the cellular network. Otherwise, the UE may not be able to do so.

### BRIEF DESCRIPTION OF THE DRAWINGS

FIG. 1 illustrates an example of a network environment, in accordance with some embodiments.

FIG. 2 illustrates a Fifth Generation (5G) network environment, in accordance with some embodiments.

FIG. 3 illustrates an example of a network coverage, in accordance with some embodiments.

FIG. 4 illustrates an example of a discontinuous coverage, in accordance with some embodiments.

FIG. 5 illustrates an example of initial and dynamic path information available in the context of discontinuous coverage, in accordance with some embodiments.

FIG. 6 illustrates an example of updates to path information and related uses, in accordance with some embodiments.

FIG. 7 illustrates an example of operational modes available to a device in a discontinuous network coverage, in accordance with some embodiments.

FIG. 8 illustrates an example of a sequence diagram in the context of discontinuous network coverage, in accordance with some embodiments.

FIG. 9 illustrates another example of a sequence diagram in the context of discontinuous network coverage, in accordance with some embodiments.

FIG. 10 illustrates an example of an operational flow/algorithmic structure implemented by a device in the context of discontinuous network coverage, in accordance with some embodiments.

FIG. 11 illustrates an example of an operational flow/algorithmic structure implemented by a base station in the context of discontinuous network coverage, in accordance with some embodiments.

FIG. 12 illustrates an example of receive components, in accordance with some embodiments.

FIG. 13 illustrates an example of a UE, in accordance with some embodiments.

FIG. 14 illustrates an example of a base station, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art, having the benefit of the present disclosure, that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Generally, a device communicates with a network when the device is in a network coverage of the network. The network coverage can be provided via a base station of the network. In certain situations, the base station may be physically movable relative to the device. For example, the base station can be implemented in a communications satellite that orbits around the Earth. In other situations, the device may be physically movable relative to the base station (e.g., when the device is a mobile device traveling on a surface of Earth). Of course, there can be situations where both the device and the base station are movable relative to each other. In these different situations, a relative path may exist between the device and the base station.

When the network coverage provided by the base station is no longer available to the device (e.g., because of an orbital location of a communications satellite and/or a geographical location of the device), the device may no longer be able to communicate with the network until the network coverage becomes available again to the device (where this “re-coverage” can be provided by the same base station or a different base station). The time interval during which the device is in the network coverage may be referred to herein as “access duration” (to connote the fact that the device can have access to the network). In comparison, where the device is outside the network coverage, the corresponding time duration may be referred to herein as a “gap duration” (to connote the fact that a network coverage gap exists).

If the device's behavior is the same during the access duration and the gap duration, the power consumption of the device may not be optimal. For instance, during the gap duration, the device may attempt to connect to the network, but such connection may not be possible. As such, the device may unnecessarily consume power. To improve at least the power consumption, the device's behavior can be modified if discontinuous coverage is expected. For instance, the device may be configured to forgo attempting to connect to the network during the gap duration.

To enable the discontinuous coverage-based behavior, the device may determine path information indicating the relative path between the device and the base station. For instance, in the case of the communications satellite, device can receive, from the network, almanac information indicating an orbit of the communications satellite and ephemeris information indicating multiple positions or at least one position and a velocity of the communication satellite. Such information can be received in system information blocks (SIBs) and/or non-access stratum signaling. Based on the path information, the device can determine whether the device is in the network coverage provided by the base station or is outside of the network coverage. For instance, the device can determine the access duration during which the device is expected to be in the network coverage. During the access duration, the access stratum layer of the device can be activated, and one or more non-access stratum procedures can be performed to establish communication between the device and the network via the base station. The device can then transfer data to the network and vice versa. When the device is outside the network coverage (e.g., during the gap duration), the access stratum layer can be deactivated, and the non-access stratum layer of the device can be notified about this deactivation. The device can then forgo performing different procedures including non-access stratum procedures, thereby reducing its power consumption.

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “device” as used herein refers to a device with radio communication capabilities, one or more processors, and one or more memory. The device may be configured as a UE that supports one or more configurations.

The term “user equipment” or “UE” as used herein refers to a device with radio communication capabilities and may describe a remote user of network resources in a communications network. The term “user equipment” or “UE” may be considered synonymous to, and may be referred to as, client, device, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface. The UE may have a primary function of communication with another UE or a network and the UE may be integrated with other devices and/or systems (e.g., in a vehicle).

The term “base station” as used herein refers to a device with radio communication capabilities, that is a device of a communications network (or, more briefly, network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network.

The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

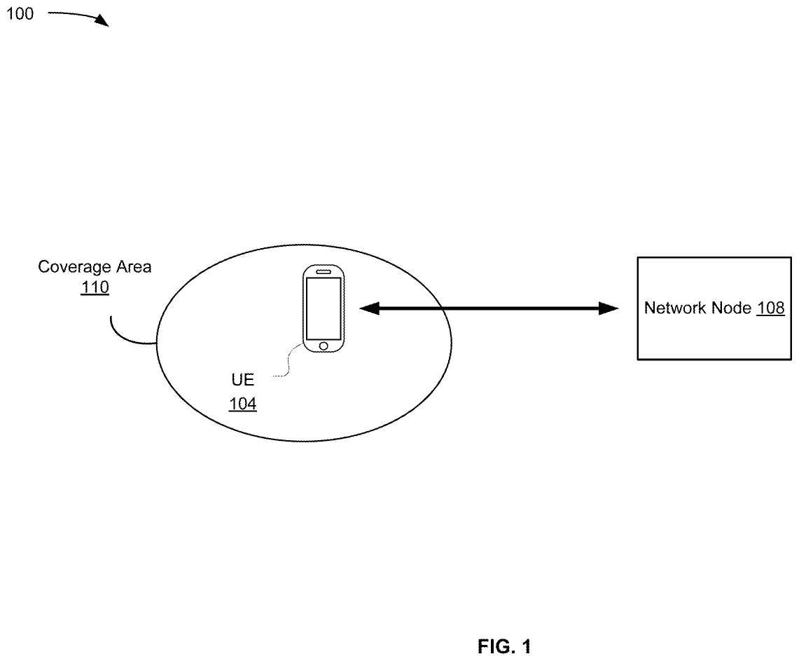

FIG. 1 illustrates a network environment 100, in accordance with some embodiments. The network environment 100 may include a UE 104 and a network node 108. The network node 108 may be a base station that provides a wireless access cell; for example, a Third-Generation Partnership Project (3GPP) New Radio (NR) cell, through which the UE 104 may communicate with the network node 108. This base station may be a component of a terrestrial network, a component of a non-terrestrial network, or components distributed between a terrestrial network and a non-terrestrial network. The UE 104 and the network node 108 may communicate over an interface compatible with 3GPP technical specifications, such as those that define Fifth-Generation (5G) NR system standards.

The network node 108 may transmit information (for example, data and control signaling) in the downlink direction by mapping logical channels on the transport channels, then transport channels onto physical channels. The logical channels may transfer data between a radio link control (RLC) and media access control (MAC) layers; the transport channels may transfer data between the MAC and PHY layers; and the physical channels may transfer information across the air interface. The physical channels may include a physical broadcast channel (PBCH); a physical downlink control channel (PDCCH); and a physical downlink shared channel (PDSCH).

The PBCH may be used to broadcast system information that the UE 104 may use for initial access to a serving cell. The PBCH may be transmitted along with physical synchronization signals (PSS) and secondary synchronization signals (SSS) in a synchronization signal (SS)/PBCH block. The SS/PBCH blocks (SSBs) may be used by the UE 104 during a cell search procedure and for beam selection.

The PDSCH may be used to transfer end-user application data, signaling radio bearer (SRB) messages, system information messages (other than, for example, MIB), and paging messages.

The PDCCH may transfer downlink control information (DCI) that is used by a scheduler of the network node 108 to allocate both uplink and downlink resources. The DCI may also be used to provide uplink power control commands, configure a slot format, or indicate that preemption has occurred.

The network node 108 may also transmit various reference signals to the UE 104. The reference signals may include demodulation reference signals (DMRSs) for the PBCH, PDCCH, and PDSCH. The UE 104 may compare a received version of the DMRS with a known DMRS sequence that was transmitted to estimate an impact of the propagation channel. The UE 104 may then apply an inverse of the propagation channel during a demodulation process of a corresponding physical channel transmission.

The reference signals may also include CSI-RS. The CSI-RS may be a multi-purpose downlink transmission that may be used for CSI reporting, beam management, connected mode mobility, radio link failure detection, beam failure detection and recovery, and fine-tuning of time and frequency synchronization.

The reference signals and information from the physical channels may be mapped to resources of a resource grid. There is one resource grid for a given antenna port, subcarrier spacing configuration, and transmission direction (for example, downlink or uplink). The basic unit of an NR downlink resource grid may be a resource element, which may be defined by one subcarrier in the frequency domain, and one orthogonal frequency division multiplexing (OFDM) symbol in the time domain. Twelve consecutive subcarriers in the frequency domain may compose a physical resource block (PRB). A resource element group (REG) may include one PRB in the frequency domain, and one OFDM symbol in the time domain, for example, twelve resource elements. A control channel element (CCE) may represent a group of resources used to transmit PDCCH. One CCE may be mapped to a number of REGs; for example, six REGs.

Transmissions that use different antenna ports may experience different radio channels. However, in some situations, different antenna ports may share common radio channel characteristics. For example, different antenna ports may have similar Doppler shifts, Doppler spreads, average delay, delay spread, or spatial receive parameters (for example, properties associated with a downlink received signal angle of arrival at a UE). Antenna ports that share one or more of these large-scale radio channel characteristics may be said to be quasi co-located (QCL) with one another. 3GPP has specified four types of QCL to indicate which particular channel characteristics are shared. In QCL Type A, antenna ports share Doppler shift, Doppler spread, average delay, and delay spread. In QCL Type B, antenna ports share Doppler shift and Doppler spread. In QCL Type C, antenna ports share Doppler shift and average delay. In QCL Type D, antenna ports share spatial receiver parameters.

The network node 108 may provide transmission configuration indicator (TCI) state information to the UE 104 to indicate QCL relationships between antenna ports used for reference signals (for example, synchronization signal/PBCH or CSI-RS) and downlink data or control signaling (for example, PDSCH or PDCCH). The network node 108 may use a combination of RRC signaling, MAC control element signaling, and DCI, to inform the UE 104 of these QCL relationships.

The UE 104 may transmit data and control information to the network node 108 using physical uplink channels. Different types of physical uplink channels are possible, including a physical uplink control channel (PUCCH) and a physical uplink shared channel (PUSCH). Whereas the PUCCH carries control information from the UE 104 to the network node 108, such as uplink control information (UCI), the PUSCH carries data traffic (e.g., end-user application data) and can carry UCI.

In an example, communications with the network node 108 and/or the base station can use channels in the frequency range 1 (FR1) band (between 40 Megahertz (MHz) and 7,125 MHz) and/or frequency range 2 (FR2) band (between 24,250 MHz and 52,600 MHz), although other frequency ranges are possible (e.g., a frequency range having a frequency larger than 52,600 MHz). The FR1 band includes a licensed band and an unlicensed band. The NR unlicensed band (NR-U) includes a frequency spectrum that is shared with other types of radio access technologies (RATs) (e.g., LTE-LAA, WiFi, etc.). A listen-before-talk (LBT) procedure can be used to avoid or minimize collision between the different RATs in the NR-U, whereby a device applies a clear channel assessment (CCA) check before using the channel.

As further illustrated in FIG. 1, the UE 104 can be located within a coverage area 110. In particular, the network node 108 may provide coverage area 110 with signaling (e.g., which may be carried by one or more beams). The coverage area 110 may represent a cell or a portion of the cell that the network node 108 provides. The coverage area 110 may contain multiple UEs, similar to the UE 104. These UEs may communicate with the network node 108 on both the uplink and the downlink based on channels available to them when the UEs are in the coverage area 110.

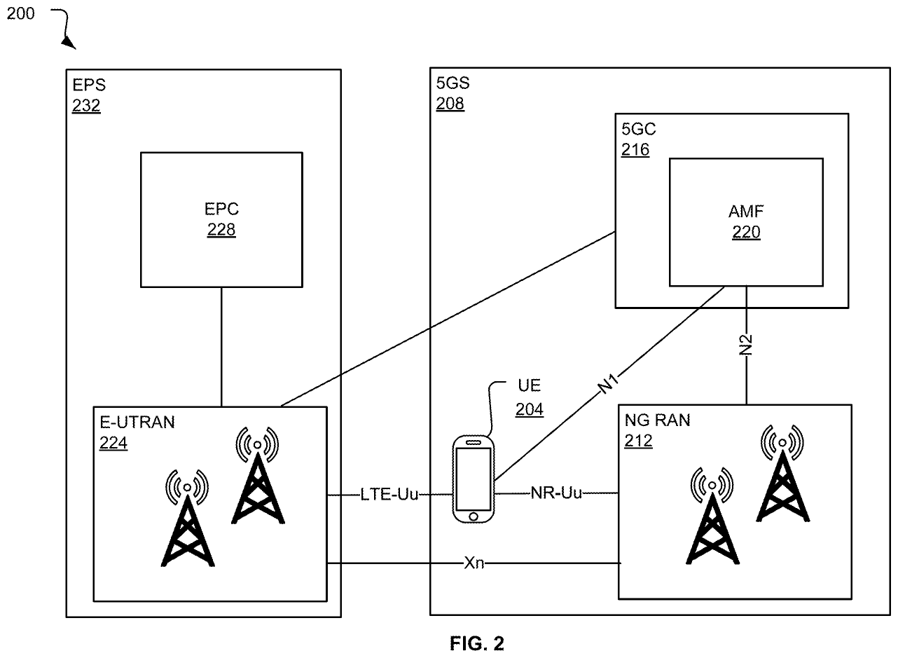

FIG. 2 illustrates a Fifth Generation (5G) network environment 200, in accordance with some embodiments. The network environment 200 may include a UE 204 that is part of a 5G system (5GS) 208. The UE 104 may be an example of the UE 104 of FIG. 1. The 5GS 208 may also include a 5G access network, for example, next generation (NG) radio access network (RAN) 212, and a 5G core network, for example, 5GC 216. The NG RAN 212 may include base stations, for example, gNBs, that provide new radio (NR) user plane and control plane protocol terminations toward the UE 204. The NG RAN 212 may be coupled with an access and mobility management function (AMF) 220 of the 5GC 216.

The components of the network environment 200 may be coupled with one another over various interfaces (or reference points) that define signaling protocols between respective components. The interfaces may include a N1 interface between the UE 204 and the AMF 220 (e.g., between a NAS layer, or NAS for brevity, of the UE with the AMF 220); an N2 interface between the NG RAN 212 and the AMF 220; an NR-Uu interface between the UE 204 and the NG RAN 212; an LTE-Uu interface between the UE 204 and an evolved universal terrestrial access network (E-UTRAN) 224; and an Xn interface between the E-UTRAN 224 and the NG RAN 212. The E-UTRAN 224 may be part of an evolved packet system (EPS) 232 that includes an evolved packet core (EPC) 228. An interface between the E-UTRAN 224 and the EPC 228 can be an S1 interface. It will be understood that these interfaces define end-to-end signaling protocols between respective components. The actual signals may traverse through other components. For example, while signals between the AMF 220 and the UE 204 may be exchanged using N1 protocols, the signals may be communicated through one or more nodes of the NG RAN 212.

The AMF 220 may be a control plane function that provides registration management, connection management, reachability management, and mobility management services. Registration management may allow the UE 204 to register and deregister with the 5GS 208. Upon registration, the UE context may be created within the 5GC 216. The UE context may be a set of parameters that identify and characterize the UE 204. The UE context may include UE identity information, UE capability information, access and mobility information, or protocol data unit (PDU) session information.

The AMF 220, and 5GS 208, in general, may perform a number of registration area management functions to allocate/reallocate a registration area to the UE 204. A registration area may include a set of tracking areas, with each tracking area including one or more cells that cover a geographical area. A tracking area is identified by a tracking area identity, which may be broadcast in the cells of a tracking area.

Connection management may be used to establish and release control plane signaling connection between the UE 204 (e.g., the NAS) and the AMF 220. Establishing a control plane signaling connection moves the UE 204 from connection management (CM)-IDLE to CM-CONNECTED.

Mobility management may be used to maintain knowledge of a location of the UE 204 within a network. Mobility management may be performed by 5GS mobility management (5GMM) sublayers of the NAS within the UE 204 and the AMF 220 to support identification, security, and mobility of the UE 204 and to provide connection management services to other sublayers.

The 5GMM sublayers may be associated with different states that are independently managed per access type (for example, 3GPP access or non-3GPP access). The 5GMM sublayers may be in a 5GMM-DEREGISTERED state if no 5GMM context has been established and the UE location is not known to the network. To establish the 5GMM context, the sublayers may engage in an initial registration, to enter the 5GMM-REGISTERED-INITIATED state and, once the initial registration is accepted, the sublayers may enter the 5GMM-REGISTERED state with a 5GMM context established. From the 5GMM-REGISTERED state, the sublayers may enter a 5GMM DEREGISTERED-INITIATED state once a deregistration is requested. Once the deregistration is accepted, the sublayers may enter the 5GMM-DEREGISTERED state. From the 5GMM-REGISTERED state, the sublayers may also enter a 5GMM-SERVICE-REQUEST-INITIATED state by initiating a service request and may re-enter the 5GMM-REGISTERED state once the service request is accepted, rejected, or fails. A service request, as used herein, may refer to both control plane and user plane service requests.

The 5GMM sublayers may have 5GMM-CONNECTED mode and a 5GMM-IDLE mode that affect how the various procedures are performed.

A 5GMM-CONNECTED mode with RRC inactive indication (or RRC suspended state) is a NAS state introduced by 3GPP to improve resume and suspend operations of an RRC connection by reducing a time taken to reactivate the suspended bearer(s) as compared to long term evolution (LTE) methods to release an RRC connection and activate the RRC connection using a service request procedure. Faster resumption or suspension of active data radio bearers (DRBs) may improve user experience and reduce usage of radio resources.

The UE 204 can operate in a 5GMM-CONNECTED mode with an inactive indication (which can be thought of as a connectivity mode of the NAS layer with the AMF 220 over the signaling control plane) and in an RRC_INACTIVE state (which can be thought of as a connectivity state of the access stratum (AS) layer with the network over a data plane, whereby the UE 204 is not receiving and/or transmitting data). The UE 204 can also operate in the 5GMM-CONNECTED mode for the NAS layer and an RRC_CONNECTED state for the AS layer (whereby the UE 204 is receiving and/or transmitting data).

The UE 204 can implement as baseband processor that supports a non-access stratum (NAS) and an access stratum (AS) (also referred to herein as a NAS layer and an AS layer, respectively). The NAS may include a 5G NAS and a legacy NAS. The legacy NAS may include a communication connection with a legacy AS. The 5G NAS may include communication connections with both a 5G AS, a non-3GPP AS, and Wi-Fi AS. The 5G NAS may include functional entities associated with both access stratums. Thus, the 5G NAS may include multiple 5G MM entities and 5G session management (SM) entities. The legacy NAS may include functional entities such as a short message service (SMS) entity, an EPS session management (ESM) entity, a session management (SM) entity, an EPS mobility management (EMM) entity, and a mobility management (MM)/GPRS mobility management (GMM) entity. In addition, the legacy AS may include functional entities such as an LTE AS, a UMTS AS, and/or a GSM/GPRS AS.

The baseband processor architecture allows for a common 5G-NAS for both 5G cellular and non-cellular (e.g., non-3GPP access). The 5G MM may maintain individual connection management and registration management state machines for each connection. Additionally, the UE 204 may register to a single public land mobile network (PLMN) using 5G cellular access as well as non-cellular access. Further, it may be possible for the device to be in a connected state in one access and an idle state in another access and vice versa. There may be common 5G-MM procedures (e.g., registration, de-registration, identification, authentication, as so forth) for both accesses.

In various embodiments, one or more of the above-described functional entities of the 5G NAS and/or 5G AS may be configured to perform methods for power savings in discontinuous coverage as further described herein.

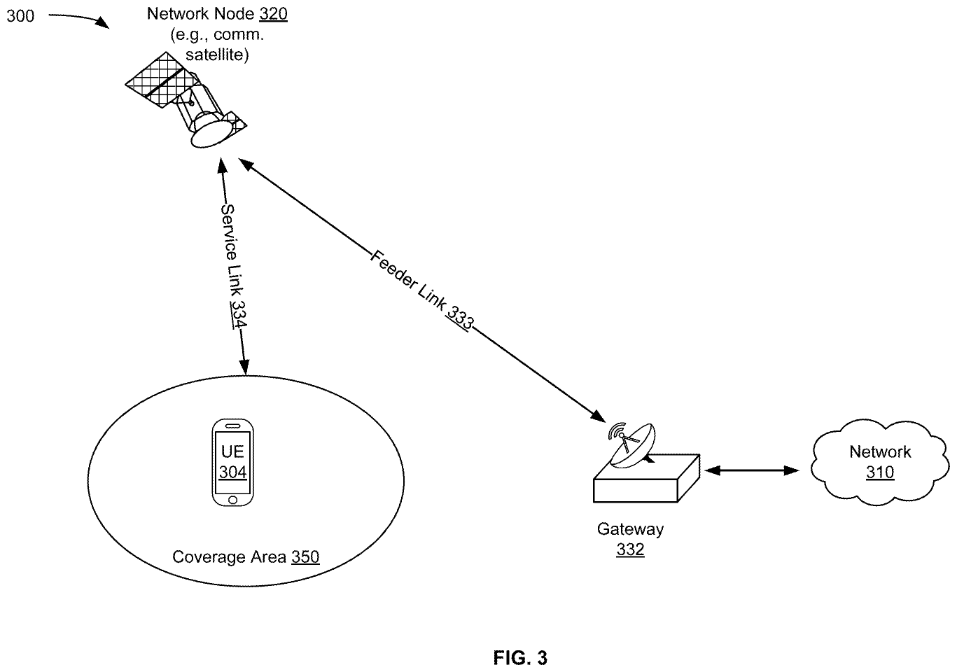

FIG. 3 illustrates an example of a network coverage 300, in accordance with some embodiments. A network 310 can be accessible to UEs via a network node 320 that supports multiple coverage areas. Each coverage area represents a geographical area within which the network coverage 300 is available. The support of the coverage areas may not be simultaneous. In particular, the network coverage 300 can be discontinuous across the coverage areas. For instance, the network coverage 300 may be available in a first coverage area for some time interval, while being unavailable in a second coverage area during that same time interval. During a different time interval, the network coverage 300 may no longer be available in the first coverage area, while being available in the second coverage area.

In an example, the network 310 can implement a particular set of radio access technologies (RATs) such as, but not limited to, 5G and/or different generation of a 3GPP network (e.g., one supported by the EPS 232 of FIG. 2). The network 310 can also be a terrestrial network, in which case the network node 320 can be a terrestrial access node, such as gNB or an eNB (or, more generally a terrestrial base station). In another example, the network 310 can be, at least in part, a non-terrestrial network where the network node 320 may be implemented on a communications satellite. In this case, the network node 320 may be referred to as a non-terrestrial base station and may be coupled with the ground network via a gateway 332.

Generally, the network node 320 can cover a large geographical area, where this area can be divided in a large number of coverage areas (potentially in the hundreds, if not thousands). A UE 304 can be located in a coverage area (show as the coverage area 350 in FIG. 3) and can connect with the network node 320 via a feeder link 324. The feeder link 324 can use mmWave or sub-mmWave frequencies (e.g., in the S band or Ka band). In this way, the UE 304 can have access to the network 310 via the network node 320.

Network coverage can be available in a coverage area based on a set of beams directed from the network node 320 to that area. This coverage can be temporary and, thus, discontinuous. For instance, the set of beams can be directed to the coverage area 350 during a first time interval and directed to a different coverage area during a second time interval. Additionally or alternatively, the network node 320 can be repositioned such that the direction of the set of beams changes from the coverage area 350 to the different coverage area.

As such, the network coverage 300 changes geographically over time. Relative to one particular coverage area (e.g., the coverage area 350), the network coverage 300 provided by the network 310 is a discontinuous network coverage in one or more coverage areas. For example, during certain time intervals, the network coverage 300 is available in the coverage area 350 (e.g., available to the UE 304 located in the coverage area 350). During other time intervals, the network coverage 300 is unavailable in the coverage area 350 (e.g., unavailable to the UE 304 located in the coverage area 350).

In the interest of clarity of explanation, various embodiments are described hereinafter in connection with a communications satellite as an example of the network node 320. Further, these various embodiments are described in connection with a device that has a narrowband internet of things (NB-IOT) configuration, an enhanced machine type communication (eMTC) configuration, or a mobile IoT configuration. However, the embodiments are not limited as such and similarly apply to any other base station that belongs to a network providing a discontinuous network coverage and/or to any other device to which the discontinuous network coverage may be provided. Furthermore, causes of the discontinuous network coverage are described as being due to the repositioning of the communications satellite. However, other causes can exist including, for instance, changes to the beam direction and/or changes to a device's position (e.g., where the device may be re-located from a coverage area to a geographical area where the network coverage is not available). The embodiments similarly apply in situations where such discontinuous network coverage causes occur.

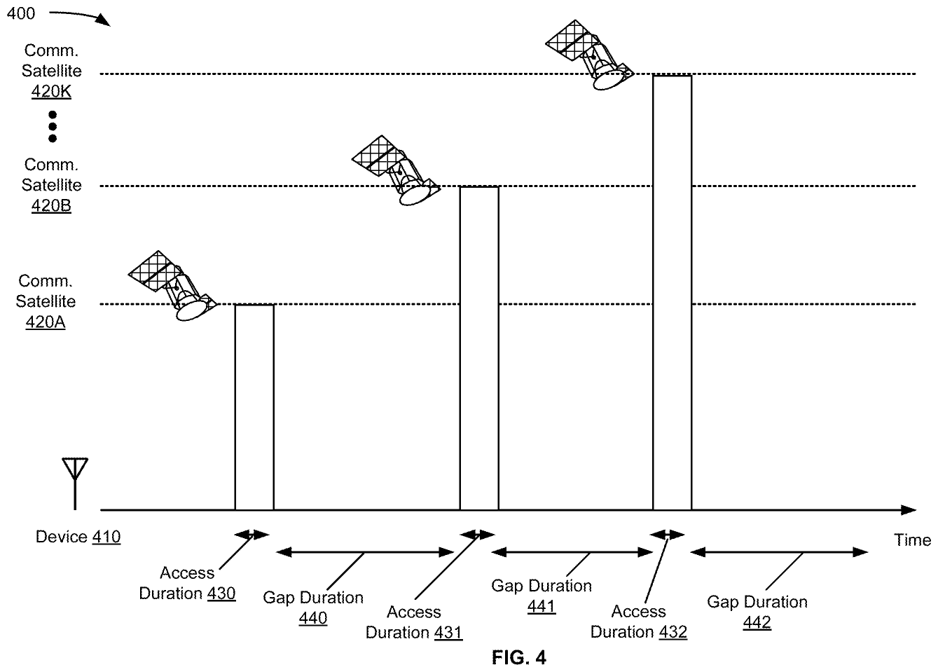

FIG. 4 illustrates an example of a discontinuous coverage 400, in accordance with some embodiments. Here, a device 410 can be located at a location on Earth. The location may be stationary. A first communications satellite 420A may be orbiting over Earth and can be part of a network (e.g., by implementing a base station of the network or components of the base station, such as a modem thereof). The network can be a public land mobile network (PLMN). The radio frequency transmission of the communications satellite 420A reaches Earth and covers a geographic area, thereby providing network coverage to the geographic area (in this case, the network coverage can be referred to as satellite coverage). As the first communications satellite 420A orbits, the RF-covered geographic area changes, thereby changing the network coverage at least geographically. When the device 410 is in the network coverage (e.g., its location is contained within the RF-covered geographic area), the device 410 has access to the network. This time duration is illustrated as an access duration 430 in FIG. 4. When the device is outside the network coverage (e.g., its location is outside the RF-covered geographic area), the device 410 no longer has access to the network (e.g., at least via the communications satellite 420A). This time duration is illustrated as a gap duration 440 in FIG. 4.

Depending on the orbiting of the communications satellite 420A, its RF transmission (e.g., beam direction) and the location of the device 410, the network coverage may become again available to the device 410 for another access duration via the communications satellite 420A. In other words, when considering only the communications satellite 420A, the device 410 can be repeatedly in and out of the discontinuous network coverage 400.

As further illustrated in FIG. 4, multiple communications satellites (shown as communications satellite 420A, 420B, . . . , 420K) may be orbiting Earth. Such communications satellites may belong to the same network (e.g., to a home PLMN (HPLMN) of the device 410) or to different networks (e.g., to the HPLMN and/or one or more visited PLMNs (VPLMNs)). As such, the device 410 can be repeatedly in and out of the discontinuous network coverage 400 provided by such communication satellites depending on their orbit positions, RF transmissions, and the location of the device 410. In the illustration of FIG. 4, the communications satellite 420A provides network coverage to the device 410 during the access duration 430, then no network coverage is provided to the device 410 during the gap duration 440. After the gap duration 440, the communications satellite 420B provides network coverage to the device 410 during a next access duration 431, after which no network coverage is available to the device 410 for the length of a gap duration 441. Thereafter also, the communications satellite 420K provides network coverage to the device 410 during a subsequent access duration 432, after which no network coverage is available to the device 410 for the length of a gap duration 442. Depending on the orbiting (e.g., velocity) and RF transmissions (e.g., beam width) of the communications satellite 420A-K, the length of the access durations 430, 431, and 432 can be different and each can vary over time, and, similarly, the length of the gap durations 440, 441, and 442 can be different and each can vary over time.

In an example, a communications satellite can be a non-geostationary satellite, such a Low-Earth-Orbit (LEO) satellite or a Medium-Earth-Orbit (MEO) satellite. LEO and MEO satellites are non-geostationary satellites orbiting around Earth with a period that varies approximately between 1.5 hour and 10 hours. LEO satellites orbit around Earth between 300-1500 km, and MEO satellites orbit around Earth between 7000-25000 km. Typically, a constellation of several non-geostationary satellites associated with handover mechanisms of a non-terrestrial network (NTN) can be used for service continuity.

In contrast, geostationary satellites have a circular orbit at 35,786 km above Earth's equator and follow the direction of Earth's rotation. An object in such an orbit has an orbital period equal to Earth's rotational period and thus appears motionless, at a fixed position in the sky, to ground devices.

NB-IOT devices and eMTC device can support NTN. The capabilities of NB-IOT devices and eMTC devices along with satellite connectivity may provide coverage beyond terrestrial deployments, where IoT connectivity is needed and can enable a standardized solution allowing global IoT operation anywhere on Earth. IoT applications rely more on LEO satellites and the coverage therein is inherently discontinuous. This applies to 4G solutions in EPS with NB-IOT/eMTC, and to solutions in 5GS (e.g., mobile IoT devices that support 5G).

Coverage gaps can appear during the rollout of NTN NB-IOT constellations. Additionally, coverage gaps occur in low density constellations as well as in deployed constellations due to satellite outage. In a low-density LEO constellation, a service link may only be available for the time the UE is within coverage of one of the satellites. The UE being in coverage of more than one satellite may occur fairly rarely. The time for which the service link is available (e.g., “access duration”) may be of only 10 seconds to few 100 seconds and the time in-between coverage (e.g., “gap duration” or “revisit time”) may extend up to several hours.

In case coverage gaps are not handled, UEs may waster power searching for cells to monitor scheduled paging occasions that coincide with coverage gaps, and on cell searches when the UE has data to transmit. The UE that wishes to transmit or has been scheduled to monitor paging at a certain time of day (within a coverage gap) can find itself unable to receive transmission from a cell and, therefore, can attempt to find a new cell and reattach. In the worst case, the UE may be unreachable from the network's point of view because scheduling occasions occur in coverage gaps. Furthermore, the UE may be disconnected from the network and attempt cell-selection and registration (NAS attach) all over. To mitigate discontinuous coverage, the UE and the network may need to be aware of gaps in coverage (e.g., be aware of discontinuous network coverage).

As such, discontinuous coverage can be inherent in NTN NB-IOT in EPS and in 5GS. Embodiments of the present disclosure relate to techniques usable to handle such coverage to avoid service degradation and extraneous UE power consumption. For example, the techniques involve any or a combination of the UE determining whether satellite coverage is available or not, timing and frequency of performing cell re-selection to remain battery power efficient, timing of performing PLMN selection, the UE determine how to prioritize HPLMN connectivity per VLPMN connection when deployments are discontinuous in coverage, the UE handling padding, and impacts to NAS timers, periodic search times, eDRX duration, and/or power save mode.

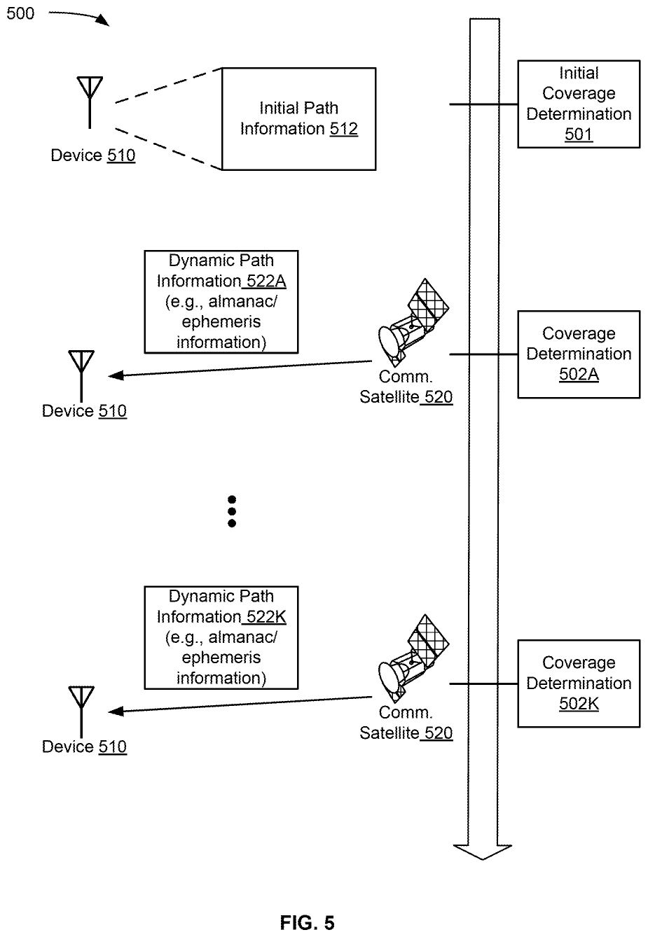

FIG. 5 illustrates an example 600 of initial and dynamic path information available in the context of discontinuous coverage, in accordance with some embodiments. Generally, path information indicates a relative path between a base station and a device, where the base station can be moving (or, if the base station is stationary, its RF transmission can be re-directed such that the base station appears to be moving relative to the device) and/or the device is moving. Given changes to the relative path, the network coverage to the device can be discontinuous. In the context of satellite coverage, the relative path corresponds to a communications satellite orbiting Earth (e.g., in a LEO or MEO orbit). In this case, the path information can include almanac information indicating an orbit of the communications satellite and ephemeris information indicating positions of the communications satellite or a position and a velocity of the communications satellite.

Generally, a satellite orbit can be described by initial conditions and a set of orbital parameters. Satellite almanac contains the coarse orbit. The almanac information can be valid and used for scheduling purposes. The short-term ephemeris can be used for uplink synchronization and can be provided in the form of at least two subsequent position broadcasts or the broadcast of a position and a velocity of the communications satellite.

In the illustration of FIG. 5, a device 510 can determine initial path information 512 as part of an initial coverage determination 501. The device 510 is an example of the device 410 and can be an NB-IOT device, an eMTC device, a mobile IoT device, or more generally a UE that supports a NTN. The initial path information 512 indicates at least first almanac information of a communications satellite 520. The initial path information 512 can be pre-stored by the device 510. Alternatively, the device 510 can remain powered up and operating in a mode that provides at least receive capabilities to receive the initial path information 512 from the NTN.

Based on the initial path information 512, the device 510 can determine when the satellite coverage is expected to be available. For instance, the user device 510 can compute an access duration during which the satellite coverage will be available to it from the communication satellite 520 based on the first almanac information. Until the start of the access duration (or, within a time margin prior to the access duration), or equivalently until the satellite coverage is over the device's 510 location (or an edge of the satellite coverage being within a distance threshold of the device's 510 location), the device 510 may operate in a first mode that saves power by having limited transmit and/or receive capabilities. Similarly, at the end the access duration (or, within a time margin after the access duration), or equivalently after device 510 is outside the satellite coverage (or an edge of the satellite coverage became at a distance threshold away from the device's 510 location), the device 510 may operate in the first mode. During the access duration (or in between the two margins), or equivalently when the device 510 is in the satellite coverage (or, in between the two distance thresholds), the device can operate in a second mode that consumes more power by having more transmit and/or receive capabilities.

Examples of these two modes are further described in connection with the next figures. For instance, in the first mode, the AS layer of the device 510 is deactivated, and the NAS layer can forgo several network procedures (e.g., a cell re-selection procedure, NAS procedures, etc.). In comparison, in the second mode, the AS layer of the device 510 is activated, and the NAS layer can perform several network procedures (e.g., a cell re-selection procedure, NAS procedures, etc.).

While the device 510 is in the satellite coverage (the device 510 would be operating in the second mode given its initial coverage determination 501), the communications satellite 520 can send dynamic path information 522A to the device 510. The dynamic path information 522A can provide updated path information that can update and/or provide more granular information about the relative path. For instance, the dynamic path information 522A can indicate updated almanac information in addition to ephemeris information. Such information can be used by the device to perform a coverage determination 502A. The coverage determination 502A can include two parts. The first part can relate to the current satellite coverage. For instance, the device 510 can further refine, based on the updated almanac information and the ephemeris information, the time length of the access duration available due to the current satellite coverage. The second part can relate to the next expected satellite coverage. For instance, the device 510 can further compute a next access duration during which the next satellite coverage is expected and/or a next gap duration until the start of the next access duration based on the updated almanac information and/or the ephemeris information.

The coverage determination can be repeated over time (illustrated in FIG. 5 by showing another coverage determination 520K using dynamic path information 522K sent from the communications satellite 520). Although FIG. 5 shows the same communications satellite 520 sending the dynamic path information during different access durations, a different communication satellite 520 can additionally or alternatively do so (e.g., whereas the communications satellite sends the dynamic path information 522A during a first access duration “A,” another communications satellite sends the dynamic path information 522K during a subsequent access duration “K”). In such situations, the almanac information and/or the ephemeris information sent from a communications satellite can be that of the communications satellite itself and/or of one or more other communications satellites. When the almanac information and the ephemeris information relate to multiple communications satellites, such satellites may belong to a same PLMN.

In an example, almanac information and/or ephemeris information are broadcasted in SIBs for scheduling and synchronization purposes. When the device 510 is at the edge of satellite coverage during an access duration, the device 510 can be configured to receive and decode ephemeris information within the access duration. The almanac information may also be available at least once per access duration (which may be referred to also as access window or access time interval). The information almanac information and/or ephemeris information can also be provided over NAS signaling during a tracking area update (TAU) procedure and/or an attach procedure in EPS or a registration procedure in 5GS. The device 510 can use almanac based predictions and ephemeris information to determine when the satellite coverage will be available to then optimize cell-search, PLMN selection and connectivity with network for energy consumption. The network (e.g., the NTN via one or more communications satellites) can provide next cell/satellite selection information or coverage gap information periodically to the device during TAU and/or mobility registration update (MRU) procedures to improve cell re-selection and/or PLMN selection procedure and to reduce power consumption.

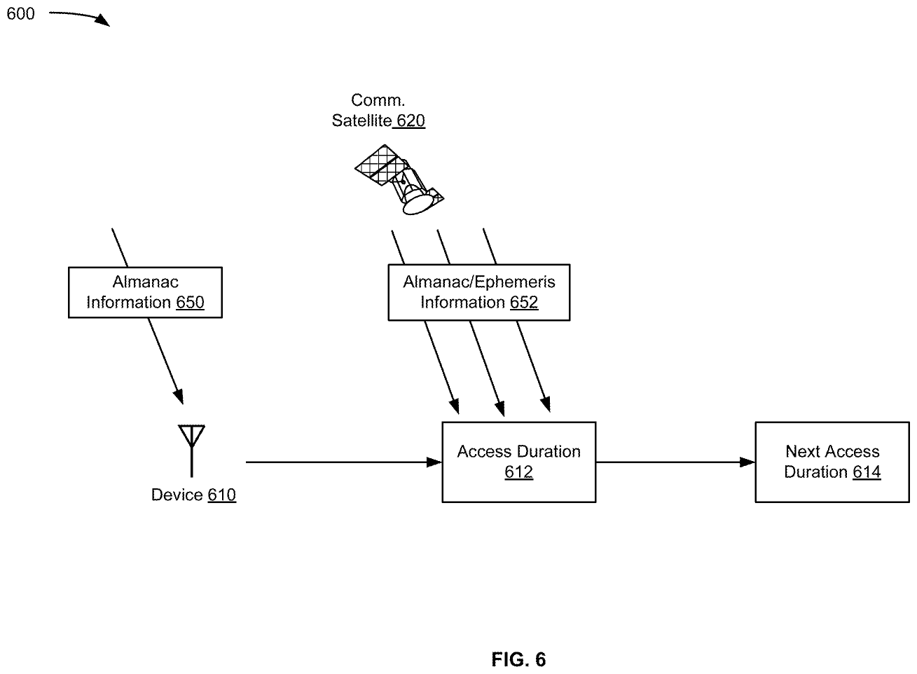

FIG. 6 illustrates an example 600 of updates to path information and related uses, in accordance with some embodiments. In the illustration of FIG. 6, the path information includes almanac information and ephemeris information. In an example, a device 610 determines almanac information 650. The device 610 is an example of the device 510 of FIG. 5. The almanac information 650 indicates an orbit of a communications satellite 620 and can be pre-stored by the device 610, previously received from an NTN, or previously received specifically from the communications satellite 620.

Based on the almanac information 650, the device 610 predicts when the satellite coverage of the satellite 620 should be available to the device 610. For instance, the device 610 predicts a timing of when its location should be in the satellite coverage by predicting at least a start of an access duration 612. The start can be computed as a function of the orbit of the communications satellite and an expected width of the satellite coverage. Whereas the orbit can be determined from the almanac information 650, the expected width can be pre-stored by the device 610 or previously communicated thereto from the NTN (and, possibly, specifically from the communications satellite 620).

When an edge of the satellite coverage is in proximity to the device's 610 location (e.g., the edge is within a threshold distance to the location), the device 610 can switch to operating in the second mode that provides the transmit and/or receive capabilities (e.g., where its AS layer is activated). This proximity can be determined by using information about the access duration 612. For instance, when the current time is within a threshold time from the start of the access duration 612, the device 610 can determine the proximity.

While in the second mode (e.g., after the start of the access duration 612), the 610 may start uplink synchronization. For example, the device 610 can perform SIB acquisition. One or more SIBs can be received and can indicate updated almanac information and/or ephemeris information 652. Based on the updated almanac information and/or ephemeris information 652, the device 610 can refine the update its information about the access duration 612 and/or can predict a next access duration 614. For instance, based on the ephemeris information (e.g., at least two satellite positions or at least a satellite position and a satellite velocity) and based on the satellite coverage's expected width, the device 610 can predict a timing of when its location should no longer be in the satellite coverage. This timing corresponds to an end of the access duration. Based on the updated almanac information and the satellite coverage's expected width, can predict a timing of when its location should be in the satellite coverage by predicting at least a start of the next access duration 614. The time difference between the end of the access duration 612 and the start of the next access duration 614 can correspond to a gap duration.

As explained herein above, the next satellite coverage need not be provided by the same communications satellite 610. In this case, at least a subset of the updated almanac information and/or the ephemeris information 652 can relate to a different communications satellite that should be providing the next satellite coverage.

Further, during the access duration 612, one or more network procedures can be performed. As part of these procedures, the NTN can send to the device 610 via the communications satellite 620, at least a subset of the updated almanac information and/or the ephemeris information 652. For instance, NAS signaling can be used during a TAU procedure or an MRU procedure for this purpose, whereby a TAU ACCEPT message or a REGISTRATION ACCEPT message can indicate the subset of the updated almanac information and/or the ephemeris information 652.

In other words, one or more SIBs can indicate at least a first subset of the updated almanac information and/or the ephemeris information 652, whereas NAS signaling can be used to indicate a remaining subset of updated almanac information and/or the ephemeris information 652. The device 610 can use first subset and/or the second subset jointly or independently of each other to update its information about the access duration 612 and/or generate information about the next access duration 614 (or, equivalently, the gap duration).

In an example, the SIB broadcast indicates the same or updated almanac information and/or the ephemeris information. The SIB broadcast can also indicate whether the device is to read such information from the SIB broadcast. The device can also be pre-configured (e.g., pre-store in its volatile memory) almanac information and/or the ephemeris information along with a validity duration during which such information remains valid. If the SIB broadcast indicates that the read is not needed, the device can forgo this reading in case the validity duration indicates that the device's preconfigured information is still valid. Otherwise, the device can read the information SIB broadcast.

Each of the almanac information and ephemeris information can be sent by the network as an information element (IE). For instance, the almanac information can be set as:

alamanacWNa INTEGER (0..255)
Number of AlmanacElements
List of AlmanacElements

The almanac elements “AlmanacElements” can be set as:

| | |
|---|---|
| SatelliteID | INTEGER (0..65535) |
| almanacE | INTEGER (0..65535) |
| almanacToa | INTEGER (0..255) |
| almanacKsii | INTEGER (−32768..32767) |
| almanacOmegaDot | INTEGER (−32768..32767) |
| almanacSVhealth | INTEGER (0..255) |
| almanacAPowerHalf | INTEGER (0..16777215) |
| almanacOmega0 | INTEGER (−8388608..8388607) |

Similar, the ephemeris information can be set as:

Number of EphemerisElements
List of EphemerisElements

The ephemeris elements “EphemerisElements” can be set as:

| Epoch (Date) | Year/Month/Day (2018/10/26) |
|---|---|
| Epoch (Time) | Hour/Minute/Second (02/00/00.000) |
| Position_X (km) | 19151.529 |
| Position_Y (km) | −37578.251 |
| Position_Z (km) | 17.682 |

Velocity_X dX/dt: (km/sec) −0.00151
Velocity_Y dY/dt: (km/sec) −0.00102
Velocity_Z dZ/dt: (km/sec) −0.00106

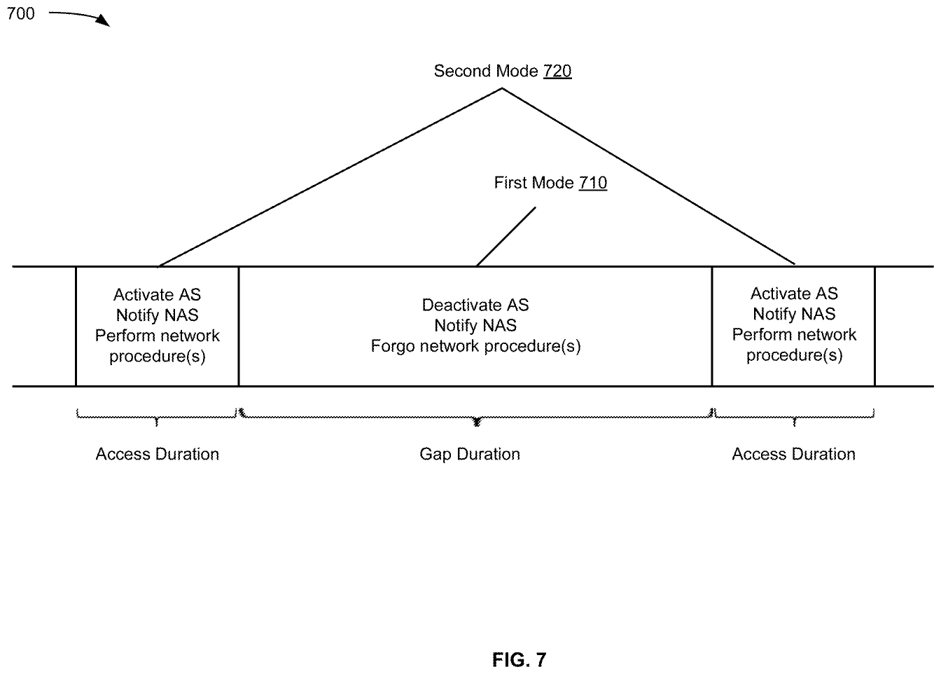

FIG. 7 illustrates an example 700 of operational modes available to a device in a discontinuous network coverage, in accordance with some embodiments. The example 700 illustrates two operational modes: a first operational mode 710 and a second operational mode 720, whereby the device has more transmit and received capabilities and thus consumers more power when operating in the second operational mode 720 relative to the first operational mode 710. The first operational mode 710 can be used during a gap duration during which network coverage is not available to the device, whereas the second operational mode 720 can be used during an access duration during which the network coverage is available to the device.

In an illustrative use case, in the first operational mode 710, the AS layer can be deactivated, thereby disabling at least data send/receive functionalities via the AS layer. Further, the NAS layer can be notified about the AS layer deactivation (e.g., via a message or a flag). Based on this notification, the NAS layer can forgo performing some or all network procedures. Such network procedures include, for instance, a cell re-selection procedure and NAS procedures such as PLMN selection, TAU update, registration update, and the like. In comparison, the second operational mode 720 enables the device to perform the network procedures including. The second operational mode 720 also enables the device to receive path information. The AS layer of the device can be activated in the second operational mode 720, whereby upon completing some or all of the network procedures, the device can send and/or receive data using its AS layer.

In addition, because the second operational mode 720 is usable during the access duration, the performed network procedures should be completed within the access duration. As such, timers used by the network procedures can be set to be smaller than or equal to the access duration. For instance, a timer used in a NAS procedure can have a value, where this value is set based on the prediction about the length of the access duration (e.g., the difference between the predicted start and end of such access duration), where the prediction is based on path information. In other words, the value of the NAS procedure timer can be based on almanac information and/or ephemeris information.

In the example 700, the device can determine whether it is subject to discontinuous network coverage and, if so, can operate in the first and second operational modes 710 and 720 depending on the network coverage availability. For instance, the device determines whether the network is a terrestrial network (TN) or is an NTN. If NTN, the device can expect discontinuous network coverage for IOT applications (e.g., when using NB-IOT, eMTC, or 5G mobile IoT). Different techniques are available for this determination. For instance, the device can be pre-configured and can pre-store data indicating that it is set up to connect with an NTN only. In another illustration, the determination can be completed during SIB1 acquisition, whereby an SIB1 message can indicate to the device that the network is an NTN.

A NAS procedure performed in the second operational mode 720 can enable the device to send one or more device identifiers to the network, where at least one of such device identifier can indicate a device configuration and one or more supported RATs. The configuration can be at least one of an NB-IOT configuration, an (eMTC configuration, or a mobile IoT configuration. A supported RAT can be an E-UTRAN or an NG-RAN. For instance, the device identifier includes a bit indicating satellite access and a set of bits indicating a selection of an IoT non-terrestrial network in one or more access technologies. In this illustration, the device identifier can be a universal subscriber identity module (USIM) that uses a new access technology identifier for satellite access (e.g., in EPS) having an EFP_{LMNwAcT} (user controlled PLMN selector with access technology) format. For PLMN access technology identifier, bits “1” and “2” can be reserved, bit “3” can indicate satellite access, bit “4” can indicate NG RAN access, bit “5” can indicate E-UTRAN in NB-S1 mode, bit “6” can indicate E-UTRAN in WB-S1 mode, bit “7” can indicate E-UTRAN access, and bit “8” can indicate UTRAN access. Accordingly, for IOT NTN in EPS with E-UTRAN, bits “3” and “7” are set. For IOT NTN in 5GS with NG RAN, bits “3” and 4″ are set. For IOT NTN in EPS with E-UTRAN and 5GS with NG RAN, bits “3,” “4” and “7” are set. Alternatively, separate bits can be used for satellite access over NG-RAN and satellite access over EUTRAN. Using such separate bits can help the device to identify if its satellite access support is over NG-RAN or over E-UTRAN separately or for both RATs. For instance, two sets of separate bits (referred to herein as bits “1” for the first set and bits “2” for the second set) are added, where one of them is for IOT NTN over E-UTRAN and the other is for IoT NTN over NG-RAN. Bits “1” are set to indicate IoT NTN over E-UTRAN, and bits “2” are set to indicate IOT NTN over NG-RAN.

As far as AS and NAS activation, the device can also disable AS functions based on almanac and ephemeris information to optimize power consumption. When the device is in a coverage area (e.g., a satellite coverage area) and the AS layer is activated, the AS layer can notify the NAS layer about the activation. The device does not search for a cell or PLMN when in coverage gap.

As far as a PLMN search, the device conducts PLMN search when in a coverage area prioritizing HPLMN connectivity. The value of periodic search timer T may be adjusted so that device conducts PLMN search when in a HPLMN coverage to maximize chances of the device gaining HPLMN connectivity (e.g., this value is set to be smaller than or equal to an access duration). To optimize high priority PLMN searches for searching high priority PLMN having satellite access, the device can utilize ephemeris and/or almanac data provided on a VPLMN and further determine the device's location. This information can be used by the device to determine if it needs to perform more frequent higher priority PLMN searches or skip the searches altogether. Alternatively, the device can be provided almanac and ephemeris data of home and/or higher priority PLMNs when camped and registered over VPLMN using NAS signaling messages.

If the device has no HPLMN coverage or is unable to connect to its HPLMN, the device may connect to a VPLMN. In such cases, the device may periodically search for PLMNs (including HPLMN) having a higher priority relative to the VPLMN. The higher priority PLMN search may be conducted at times when the HPLMN coverage is likely to be available based on almanac and ephemeris information (e.g., during an access duration). Further, the device can store HPLMN's satellite coverage data (e.g., almanac and/or ephemeris data) even when camped on a VPLMN. The device can use this data to fine tune its HPLMN search. If the device camps on VPLMN that provides discontinuous satellite access, then by utilizing the HPLMN's satellite coverage data, the device can search for its HPLMN. A similar approach can be adopted for higher priority PLMNs for which coverage data is stored by the device.

For further power savings, DRX and PSM can be disabled or their durations may be adapted for discontinuous network coverage so that the device wakes up when in a coverage area (e.g., during an access duration). For instance, the device remains in a sleep state of a DRX cycle or a PSM while the device is outside a network coverage and enters a wake-up state while the device is in a network coverage. A timer of the DRX cycle or the PSM is set based on at least one of almanac information or ephemeris information.

Generally, DRX is mechanism for the device to save energy, whereby the device goes into sleep (receive (RX) chain off) and wake (listen to PDCCH) states. A DRX cycle includes an ON period and an OFF period. A DRX inactivity time is used and is the time for which the device monitors PDCCH in each consecutive subframe. Once the DRX Inactivity timer expires, the device goes into the sleep state and power savings start. A DRX short cycle timer starts and once it expires, the device wakes up and checks for paging. If there is no paging or data, a DRX long cycle timer starts, and more power savings can be achieved. The normal DRX cycle is 2.56 seconds and extended DRX is 10.24 seconds in connected mode. Extended DRX cycles of up to 52 minutes for eMTC and 3 hr for NB-IOT are supported.

As far as PSM, in an idle mode, the device starts an active timer and performs all idle mode NAS functions; PLMN selection, cell selection/reselection, respond to paging etc. When the active timer expires, the device enters PSM. In PSM, the device stops all AS and NAS functions and the network does not page the device. The device starts a periodic update timer and stays in PSM mode until expiration of this timer.

Both eDRX and PSM modes are negotiated between the UE and the network in Attach/TAU or Registration/MRU. Given almanac information and/or ephemeris information, the UE and the network can negotiate values of the timers used in eDRX and PSM.

If the device wakes up to receive paging while in a coverage gap, the device likely wastes a lot of energy. Further, if the network schedules paging while the device is in the coverage gap, the device is likely unreachable. As such, the network and device should agree upon the timing of paging occasions to coincide with network coverage. The paging may not work with discontinuous network coverage (e.g., during the gap duration) and in such cases the device may use PSM.

For instance, the device may forgo performing paging information monitoring while the device is outside the network coverage. The network may forgo sending paging information to the device while the device is outside the network coverage. For instance, the device may indicate to the network via NAS signaling its prediction of an access duration or a gap duration. The device may not monitor paging information during the gap duration. Conversely, the network may not send paging information during the gap duration. Additionally or alternatively, the network itself may predict the access duration and/or gap duration and may accordingly send the paging information only during the access duration and the device may only monitor paging information during the access duration.

Various timers can also be set based on the almanac information and/or the ephemeris information. For instance, the almanac information and/or the ephemeris information are used to determine an access duration. The network can configure a periodic registration timer, a tracking area update timer, a mobile reachable timer, and/or an implicit detach timer are configured by the network based on the access duration.

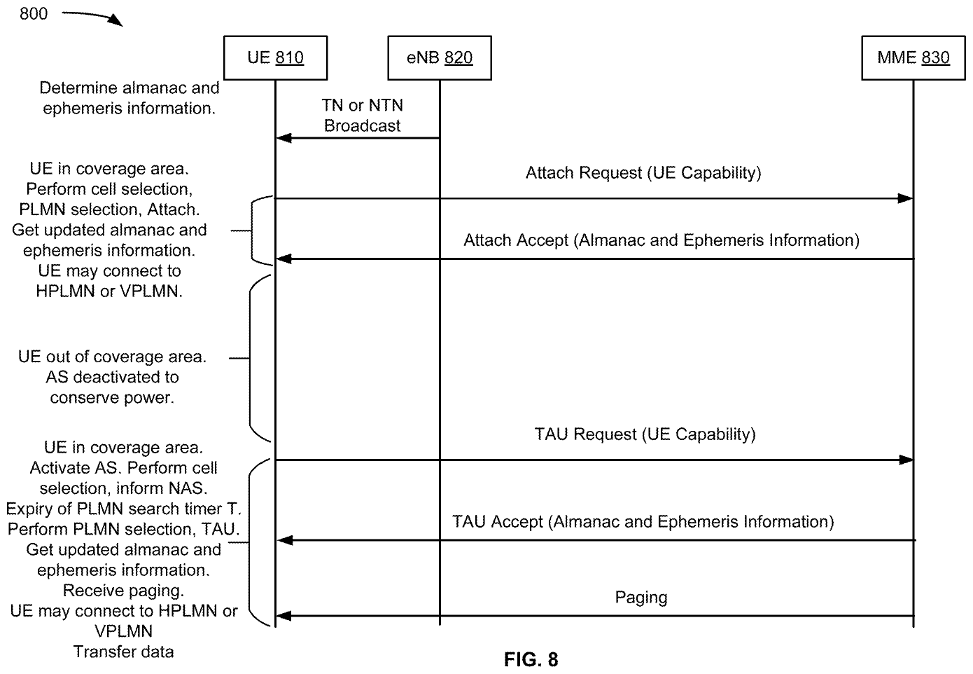

FIG. 8 illustrates an example of a sequence diagram 800 in the context of discontinuous network coverage, in accordance with some embodiments. The sequence diagram 800 can apply to a network that provides discontinuous network coverage (e.g., NTN) and that uses E-UTRAN technology. The network includes an eNB 820 (e.g., having components thereof that are implemented on a communications satellite) and a mobility management entity 830 (MME, which can be implemented as a ground component). The sequence diagram 900 includes a broadcast by the eNB 820, where this broadcast can indicate whether the network is a TN or an NTN. The broadcast can be received by a UE 810. For instance, the broadcast is a SIB1 broadcast. The broadcast can also include almanac and ephemeris information. As such, the UE 810 can determine whether the network is a TN or an NTN and can predict satellite coverage (or, more generally, network coverage) in the case of an NTN. The UE 810 is an example of the devices described herein above. In the case of an NTN, the UE may have previously camped on an NTN cell of this network. The UE can determine whether it is still camped on the same NTN cell based on, for instance, the cell ID, camped tracking area identity (TAI), and/or frequency characteristics. If it is the same NTN cell, the UE can skip reading the satellite coverage information (e.g., ephemeris and almanac information) if broadcasted by the NTN cell, as it will be same. In this way, the UE can conserve power by not reading the same information again.

When the UE 810 is in a coverage area (e.g., the network coverage is provided thereto by the eNB 820 or another eNB implemented on a communications satellite), the UE 810 can perform a cell selection, PLMN selection, and an attach procedure by operating in the relevant operational mode (e.g., the second operational mode 720). The PLMN selection may allow the UE 810 to connect to a VPLMN if HPLMN connectivity is not available. If a VPLMN is selected, the UE 810 can periodically look for a higher priority PLMN, where the periodicity is shorter than the access duration or where this searching can be performed during a next access duration. As part of the attach procedure, the UE 810 can send an attach request to the MME 830 via the applicable eNB. The attach request can include UE capability information. Further, the attach request can include a device identifier as described herein above. The MME 830 can response with an attach accept. The attach accept can include almanac and ephemeris information. The UE 810 can predict an end of the current access duration (or end of the current network coverage), a start of a next access duration (or start of the next network coverage), and/or a gap duration (or a network coverage gap) based on the almanac and ephemeris information.

Next, where the UE 810 is out of the coverage area, the UE 810 can operate in a different operational model (e.g., the first operational mode 710). For instance, the AS layer is deactivated to conserve power. The NAS layer also can forgo various network operations. The network may also forgo paging.

Thereafter, when the UE 810 is in a coverage area gain, the UE 810 can operate in the other operational mode again (e.g., the second operational mode 720). For instance, the AS layer is activated, and the NAS layer is notified. The UE 810 performs a cell selection. The UE 810 determines whether a PMN search timer expired or not. The value of this timer can be set based on almanac and ephemeris information. Upon expiry of PLMN search timer, the UE 810 performs PLMN selection and a TAU procedure. As part of the TAU procedure, the UE 810 sends a TAU request to the MME 830 via the relevant eNB, where this request can indicate the UE capability (and can include the device identifier). The MME 830 can send a TAU accept message via the relevant eNB. This message can include almanac and ephemeris information that are then used by the UE 810 to further predict the current access duration (or the current network coverage), the next access duration (or the next network coverage), and/or the next gap duration (e.g., the next network coverage gap). Further, the MME 830 can send, via the relevant eNB, paging information that the UE 810 monitors and detects.

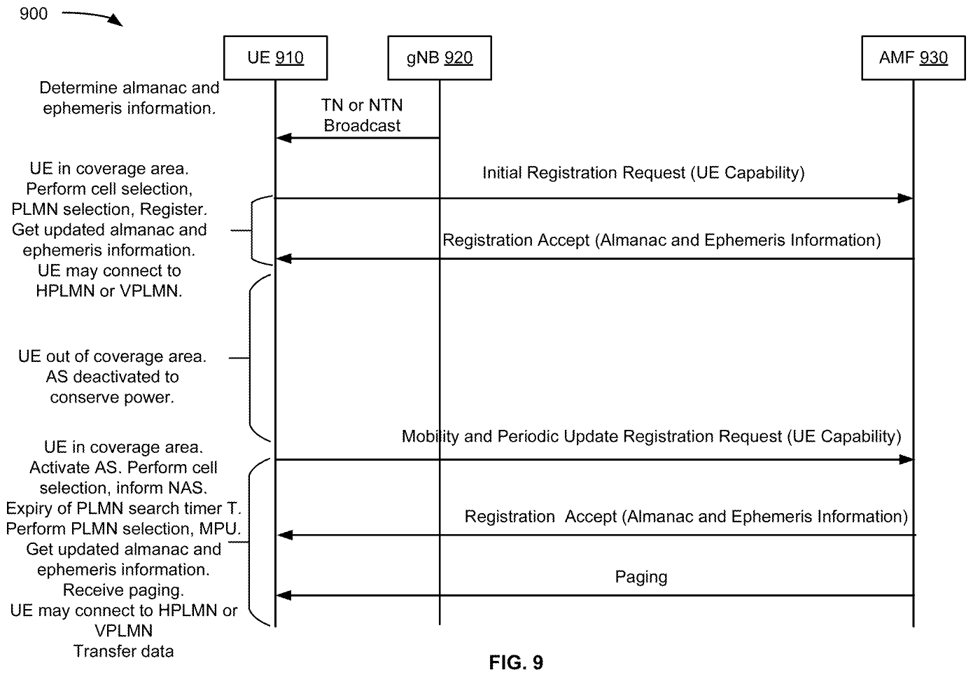

FIG. 9 illustrates another example of a sequence diagram 900 in the context of discontinuous network coverage, in accordance with some embodiments. The sequence diagram 900 can apply to a network that provides discontinuous network coverage (e.g., NTN) and that uses NG RAN technology. The network includes a gNB 920 (e.g., having components thereof that are implemented on a communications satellite) and an AMF 930 (can be implemented as a ground component). The sequence diagram 900 includes a broadcast by the gNB 920, where this broadcast can indicate whether the network is a TN or an NTN. The broadcast can be received by a UE 910. For instance, the broadcast is a SIB1 broadcast. The broadcast can also include almanac and ephemeris information. As such, the UE 910 can determine whether the network is a TN or an NTN and can predict satellite coverage (or, more generally, network coverage) in the case of an NTN. The UE 910 is an example of the devices described herein above.

When the UE 910 is in a coverage area (e.g., the network coverage is provided thereto by the gNB 920 or another gNB implemented on a communications satellite), the UE 910 can perform a cell selection, PLMN selection, and a registration procedure by operating in the relevant operational mode (e.g., the second operational mode 720). The PLMN selection may allow the UE 910 to connect to a VPLMN if HPLMN connectivity is not available. If a VPLMN is selected, the UE 910 can periodically look for a higher priority PLMN, where the periodicity is shorter than the access duration or where this searching can be performed during a next access duration. As part of the registration procedure, the UE 910 can send a REGISTRATION REQUEST message to the AMF 930 via the applicable gNB. The REGISTRATION REQUEST message can include UE capability information. Further, the REGISTRATION REQUEST message can include a device identifier as described herein above. The AMF 930 can respond with a REGISTRATION ACCEPT message. The REGISTRATION ACCEPT message can include almanac and ephemeris information. The UE 910 can predict an end of the current access duration (or end of the current network coverage), a start of a next access duration (or start of the next network coverage), and/or a gap duration (or a network coverage gap) based on the almanac and ephemeris information.

Next, where the UE 910 is out of the coverage area, the UE 910 can operate in a different operational model (e.g., the first operational mode 710). For instance, the AS layer is deactivated to conserve power. The NAS layer also can forgo various network operations. The network may also forgo paging.

Thereafter, when the UE 910 is in a coverage area gain, the UE 910 can operate in the other operational mode again (e.g., the second operational mode 720). For instance, the AS layer is activated, and the NAS layer is notified. The UE 910 performs a cell selection. The UE 910 determines whether a PMN search timer expired or not. The value of this timer can be set based on almanac and ephemeris information. Upon expiry of PLMN search timer, the UE 910 performs PLMN selection and a mobility and periodic update registration procedure. As part of this procedure, the UE 910 sends a mobility and periodic update REGISTRATION REQUEST message to the AMF 930 via the relevant gNB, where this request can indicate the UE capability (and can include the device identifier). The AMF 930 can send a REGISTRATION ACCEPT message via the relevant gNB. This message can include almanac and ephemeris information that are then used by the UE 910 to further predict the current access duration (or the current network coverage), the next access duration (or the next network coverage), and/or the next gap duration (e.g., the next network coverage gap). Further, the AMF 930 can send, via the relevant gNB, paging information that the UE 910 monitors and detects.

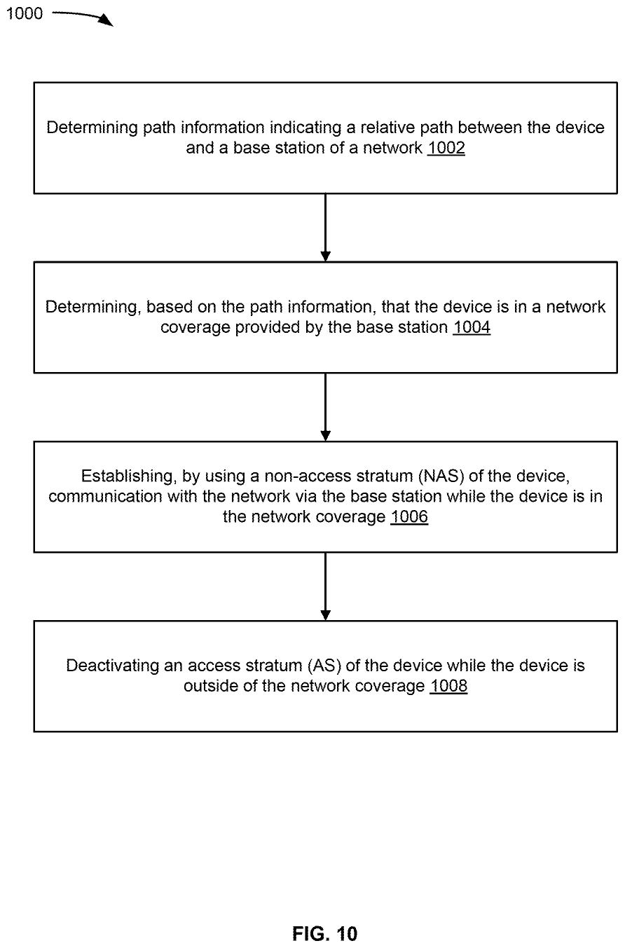

FIG. 10 illustrates an example of an operational flow/algorithmic structure 1000 implemented by a device (or components thereof) in the context of discontinuous network coverage, in accordance with some embodiments. The device is an example of any of the devices described herein above. The discontinuous network coverage may be available from an NTN.

The operational flow/algorithmic structure 1000 may include, at 1002, determining path information indicating a relative path between the device and a base station of a network, the network providing discontinuous network coverage in one or more coverage areas. For instance, the path information includes almanac information and/or ephemeris information of a communications satellite that implements the base station or components thereof. The almanac information and/or ephemeris information can be pre-stored by the device and/or received from the communications satellite or from another communications satellite during a previous access duration.

The operational flow/algorithmic structure 1000 may include, at 1004, determining, based on the path information, that the device is in a network coverage provided by the base station. For instance, the device predicts the network coverage based on the almanac information and/or ephemeris information. The prediction can include an expected start of a current access duration. Upon the expected start being within a threshold time of the current time, the device can determine that the device is in the network coverage.

The operational flow/algorithmic structure 1000 may include, at 1006, establishing, by using a NAS layer of the device, communication with the network via the base station while the device is in the network coverage. For instance, the AS layer is activated, and the NAS layer is notified of this activation. The NAS layer can perform various network operations including for instance, a SIB acquisition, a cell selection and/or NAS procedures. Additional almanac information and/or ephemeris information can be received via the SIB acquisition and/or NAS signaling. Timers used as part of the network procedures can be set to have values based on almanac information and/or ephemeris information. The device can establish a data session using the AS layer to exchange data with the network.

The operational flow/algorithmic structure 1000 may include, at 1008, deactivating an access stratum (AS) layer of the device while the device is outside the network coverage. For instance, the device determines that the network coverage is no longer available thereto (e.g., by predicting an end of the current access duration or a start of a next gap duration) based on the almanac information and/or ephemeris information. The AS layer is activated accordingly to save power.

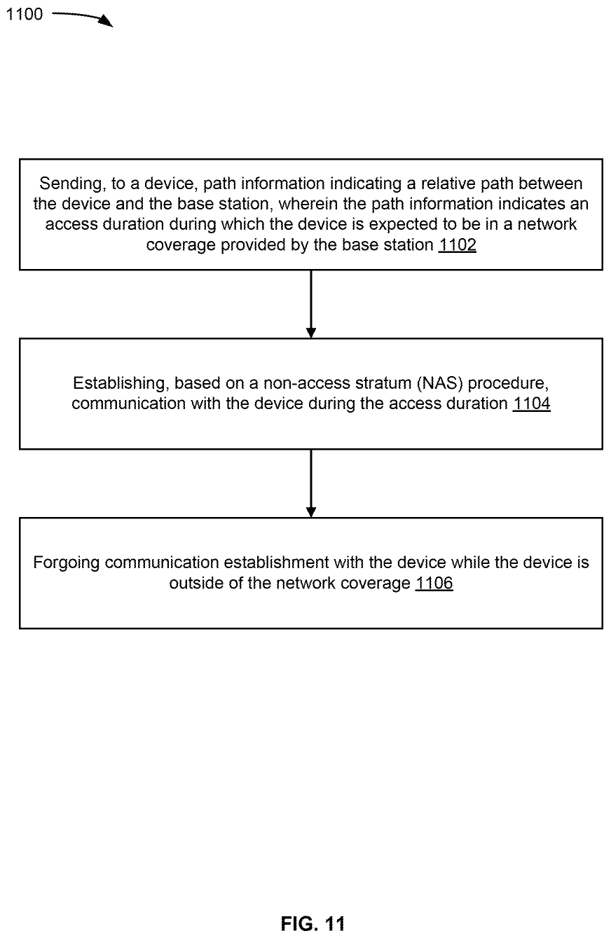

FIG. 11 illustrates an example of an operational flow/algorithmic structure 1100 implemented by a base station (or components) in the context of discontinuous network coverage, in accordance with some embodiments. The base station is an example of any of the base stations described herein above. In the context of an NTN, the base station (or the components thereof) can be implemented on a communications satellite.

The operational flow/algorithmic structure 1100 may include, at 1102, sending, to a device, path information indicating a relative path between the device and the base station, wherein the path information indicates an access duration during which the device is expected to be in a network coverage provided by the base station. For example, the path information includes almanac information and/or ephemeris information can be sent in one or more SIB messages or via NAS signaling (e.g., in an attach accept message or a registration accept message). As described herein above, the path information may be preconfigured (rather than being sent) for specific PLMNs. The pre-configuration can be in a USIM's elementary file (EF). Additionally or alternatively, the pre-configuration can be stored in the device in the non-volatile memory. The pre-configured information can be updated by the device when upon a change thereto or when the information is no longer valid (e.g., upon an expiration of the duration).

The operational flow/algorithmic structure 1100 may include, at 1104, establishing, based on a NAS procedure, communication with the device during the access duration. For instance, the NAS procedure can be an attach procedure or a registration procedure. Upon sending an accept message to the device, a communication session is established with an AS layer of the device to enable the communication.

The operational flow/algorithmic structure 1100 may include, at 1106, forgoing communication establishment with the device while the device is outside the network coverage. For instance, no paging information is sent to the device based on knowledge that the device is outside the network coverage. This knowledge can be derived locally from almanac information and/or ephemeris information or can be determined from information received from the device indicating its prediction of the network coverage (e.g., the timing of an access gap duration).

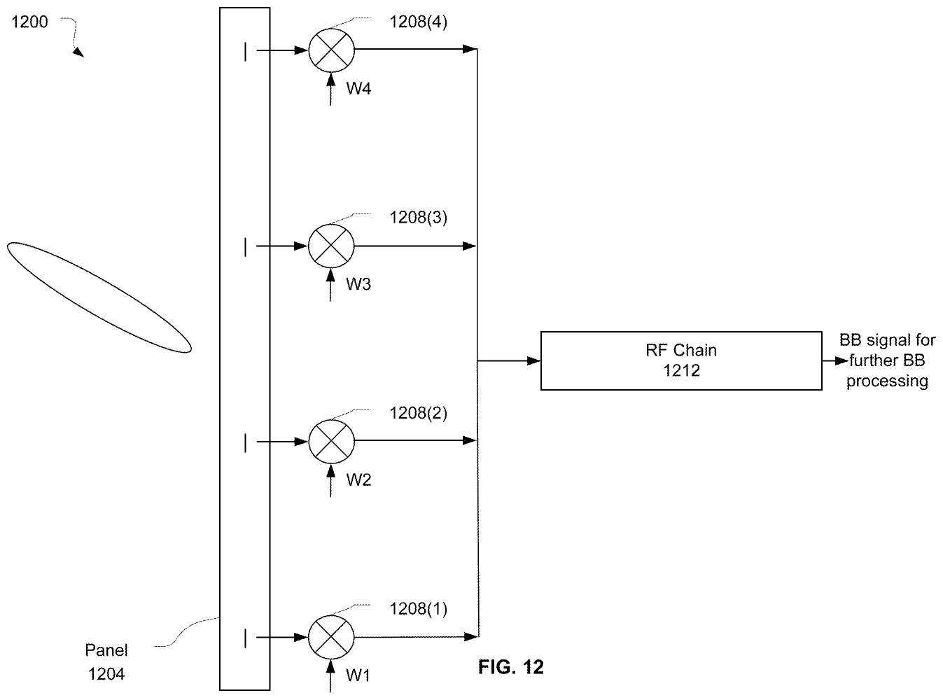

FIG. 12 illustrates receive components 1200 of the UE 104, in accordance with some embodiments. A device, such as one described in any of the above figures, can include similar receive components. The receive components 1200 may include an antenna panel 1204 that includes a number of antenna elements. The panel 1204 is shown with four antenna elements, but other embodiments may include other numbers.

The antenna panel 1204 may be coupled to analog beamforming (BF) components that include a number of phase shifters 1208(1)-1208(4). The phase shifters 1208(1)-1208(4) may be coupled with a radio-frequency (RF) chain 1212. The RF chain 1212 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (for example W1-W4), which may represent phase shift values, to the phase shifters 1208(1)-1208(4) to provide a receive beam at the antenna panel 1204. These BF weights may be determined based on the channel-based beamforming.

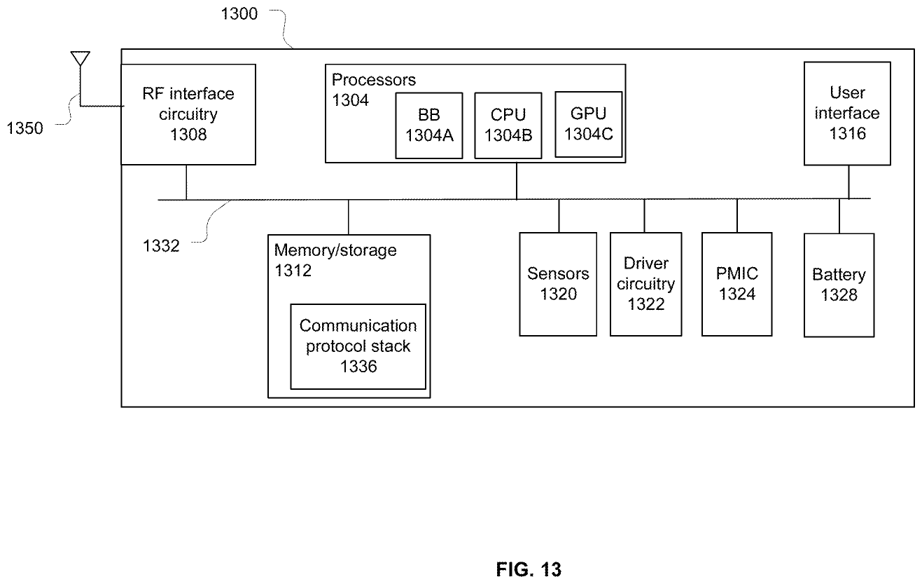

FIG. 13 illustrates a UE 1300, in accordance with some embodiments. The UE 1300 may be similar to and substantially interchangeable with UE 104 of FIG. 1. A device, such as one described in any of the above figures, can include similar components, including for instance, processors, memory, and RF interface circuitry.

Similar to that described above with respect to UE 104, the UE 1300 may be any mobile or non-mobile computing device, such as mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 1300 may include processors 1304, RF interface circuitry 1308, memory/storage 1312, user interface 1316, sensors 1320, driver circuitry 1322, power management integrated circuit (PMIC) 1324, and battery 1328. The components of the UE 1300 may be implemented as integrated circuits (ICs), portions thereof, discrete electronic devices, or other modules, logic, hardware, software, firmware, or a combination thereof. The block diagram of FIG. 13 is intended to show a high-level view of some of the components of the UE 1300. However, some of the components shown may be omitted, additional components may be present, and different arrangements of the components shown may occur in other implementations.

The components of the UE 1300 may be coupled with various other components over one or more interconnects 1332, which may represent any type of interface, input/output, bus (local, system, or expansion), transmission line, trace, optical connection, etc., that allows various circuit components (on common or different chips or chipsets) to interact with one another.

The processors 1304 may include processor circuitry, such as baseband processor circuitry (BB) 1304A, central processor unit circuitry (CPU) 1304B, and graphics processor unit circuitry (GPU) 1304C. The processors 1304 may include any type of circuitry or processor circuitry that executes or otherwise operates computer-executable instructions, such as program code, software modules, or functional processes from memory/storage 1312 to cause the UE 1300 to perform operations as described herein.

In some embodiments, the baseband processor circuitry 1304A may access a communication protocol stack 1336 in the memory/storage 1312 to communicate over a 3GPP compatible network. In general, the baseband processor circuitry 1304A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1308.

The baseband processor circuitry 1304A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 1304A may also access group information from memory/storage 1312 to determine search space groups in which a number of repetitions of a PDCCH may be transmitted.

The memory/storage 1312 may include any type of volatile or non-volatile memory that may be distributed throughout the UE 1300. In some embodiments, some of the memory/storage 1312 may be located on the processors 1304 themselves (for example, L1 and L2 cache), while other memory/storage 1312 is external to the processors 1304 but accessible thereto via a memory interface. The memory/storage 1312 may include any suitable volatile or non-volatile memory, such as, but not limited to, dynamic random-access memory (DRAM), static random-access memory (SRAM), erasable programmable read-only memory (EPROM), electrically erasable programmable read-only memory (EEPROM), Flash memory, solid-state memory, or any other type of memory device technology.

The RF interface circuitry 1308 may include transceiver circuitry and a radio frequency front module (RFEM) that allows the UE 1300 to communicate with other devices over a radio access network. The RF interface circuitry 1308 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1350 and proceed to filter and amplify (with a low-noise amplifier) the signal. The signal may be provided to a receiver of the transceiver that down-converts the RF signal into a baseband signal that is provided to the baseband processor of the processors 1304.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1350.

In various embodiments, the RF interface circuitry 1308 may be configured to transmit/receive signals in a manner compatible with NR access technologies.

The antenna 1350 may include a number of antenna elements that each convert electrical signals into radio waves to travel through the air and to convert received radio waves into electrical signals. The antenna elements may be arranged into one or more antenna panels. The antenna 1350 may have antenna panels that are omnidirectional, directional, or a combination thereof to enable beamforming and multiple input, multiple output communications. The antenna 1350 may include microstrip antennas, printed antennas fabricated on the surface of one or more printed circuit boards, patch antennas, phased array antennas, etc. The antenna 1350 may have one or more panels designed for specific frequency bands including bands in FR1 or FR2.

The user interface circuitry 1316 includes various input/output (I/O) devices designed to enable user interaction with the UE 1300. The user interface 1316 includes input device circuitry and output device circuitry. Input device circuitry includes any physical or virtual means for accepting an input, including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators, such as light emitting diodes (LEDs) and multi-character visual outputs), or more complex outputs, such as display devices or touchscreens (for example, liquid crystal displays (LCDs), LED displays, quantum dot displays, projectors, etc.), with the output of characters, graphics, multimedia objects, and the like being generated or produced from the operation of the UE 1300.

The sensors 1320 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1322 may include software and hardware elements that operate to control particular devices that are embedded in the UE 1300, attached to the UE 1300, or otherwise communicatively coupled with the UE 1300. The driver circuitry 1322 may include individual drivers allowing other components to interact with or control various input/output (I/O) devices that may be present within, or connected to, the UE 1300. For example, driver circuitry 1322 may include a display driver to control and allow access to a display device, a touchscreen driver to control and allow access to a touchscreen interface, sensor drivers to obtain sensor readings of sensor circuitry 1320 and control and allow access to sensor circuitry 1320, drivers to obtain actuator positions of electro-mechanic components or control and allow access to the electro-mechanic components, a camera driver to control and allow access to an embedded image capture device, audio drivers to control and allow access to one or more audio devices.

The PMIC 1324 may manage power provided to various components of the UE 1300. In particular, with respect to the processors 1304, the PMIC 1324 may control power-source selection, voltage scaling, battery charging, or DC-to-DC conversion.

In some embodiments, the PMIC 1324 may control, or otherwise be part of, various power saving mechanisms of the UE 1300. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1300 may power down for brief intervals of time and thus save power. If there is no data traffic activity for an extended period of time, then the UE 1300 may transition off to an RRC_Idle state, where it disconnects from the network and does not perform operations, such as channel quality feedback, handover, etc. The UE 1300 goes into a very low power state and wakes up to listen to paging from the network and then powers down again. The UE 1300 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely or shut down RF activity completely. Any data sent during this time incurs a large delay and it is assumed the delay is acceptable.

A battery 1328 may power the UE 1300, although in some examples the UE 1300 may be mounted deployed in a fixed location and may have a power supply coupled to an electrical grid. The battery 1328 may be a lithium-ion battery, a metal-air battery, such as a zinc-air battery, an aluminum-air battery, a lithium-air battery, and the like. In some implementations, such as in vehicle-based applications, the battery 1328 may be a typical lead-acid automotive battery.

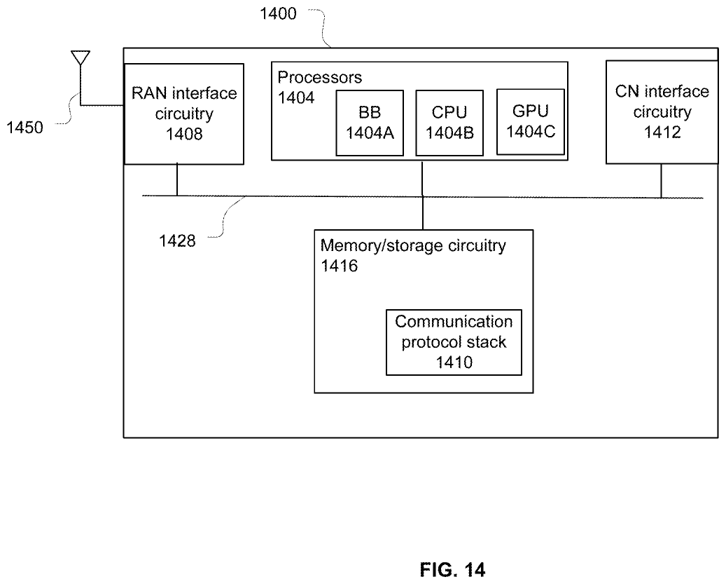

FIG. 14 illustrates a gNB 1400, in accordance with some embodiments. The gNB 1400 may be similar to and substantially interchangeable with the gNB 108 of FIG. 1.

The gNB 1400 may include processors 1404, RAN interface circuitry 1408, core network (CN) interface circuitry 1412, and memory/storage circuitry 1416.

The components of the gNB 1400 may be coupled with various other components over one or more interconnects 1428.

The processors 1404, RAN interface circuitry 1408, memory/storage circuitry 1416 (including communication protocol stack 1410), antenna 1450, and interconnects 1428 may be similar to like-named elements shown and described with respect to FIG. 13.

The CN interface circuitry 1412 may provide connectivity to a core network, for example, a Fifth Generation Core network (5GC) using a 5GC-compatible network interface protocol, such as carrier Ethernet protocols, or some other suitable protocol. Network connectivity may be provided to/from the gNB 1400 via a fiber optic or wireless backhaul. The CN interface circuitry 1412 may include one or more dedicated processors or FPGAs to communicate using one or more of the aforementioned protocols. In some implementations, the CN interface circuitry 1412 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a method implemented by a device. The method comprises: determining path information of a communications satellite of a network that provides discontinuous network coverage in one or more coverage areas; determining, based on the path information, that the device is in a satellite coverage of the communications satellite; establishing, by using a non-access stratum (NAS) layer of the device, communication with the network via the communications satellite while the device is in the satellite coverage; and deactivating an access stratum (AS) layer of the device while the device is outside of the satellite coverage.

Example 2 includes the method of example 1, further comprising: determining an access duration during which the device is expected to be in the satellite coverage, wherein the path information is determined by at least receiving almanac information and ephemeris information from the communications satellite during the access duration or a previous access duration or from a different communications satellite during the previous access duration.

Example 3 includes the method of example 2, wherein at least one of the almanac information or the ephemeris information is received in a system information block (SIB) broadcast.

Example 4 includes the method of example 2, wherein at least one of the almanac information or the ephemeris information is received in NAS signaling during an attach procedure or a registration procedure.

Example 5 includes the method of any preceding examples, further comprising: receiving, in a previous access duration, first almanac information indicating an orbit of the communications satellite, wherein the first almanac information represents a first portion of the path information, and determining, based on the first almanac information, an access duration during which the device is in the satellite coverage of the communications satellite.

Example 6 includes the method of example 5, further comprising: receiving, during the access duration, second almanac information further indicating the orbit of the communications satellite and ephemeris information indicating positions of the communications satellite or a position and a velocity of the communications satellite, wherein the second almanac information and the ephemeris information represent a second portion of the path information, and wherein the access duration is further determined based on the second portion of the path information.

Example 7 includes the method of example 6, further comprising: determining, based on the second almanac information, a next access duration or a gap duration during which the satellite coverage is unavailable to the device, wherein the AS layer is deactivated until the next access duration or during the gap duration.

Example 8 includes the method of any preceding examples, wherein establishing the communication comprises performing a cell selection procedure, a public land mobile network (PLMN) selection procedure, an attach procedure, or a registration procedure based on determining that the device is in the satellite coverage.

Example 9 includes the method of any preceding examples, determining that the network is a non-terrestrial network based on a system information block (SIB) acquisition; and determining that discontinuous coverage is expected based on the network being a non-terrestrial network and a configuration of the device, wherein the configuration is at least one of a narrowband internet of things (NB-IOT) configuration, an enhanced machine type communication (eMTC) configuration, or a mobile IoT configuration.

Example 10 includes the method of example 9, further comprising: sending, to the network, an identifier of the device, the identifier comprising a bit indicating satellite access and a set of bits indicating a selection of an IoT non-terrestrial network in one or more access technologies.

Example 11 includes a method implemented by a device. The method comprises: determining path information indicating a relative path between the device and a base station of a network, the network providing discontinuous network coverage in one or more coverage areas; determining, based on the path information, that the device is in a network coverage provided by the base station; establishing, by using a non-access stratum (NAS) layer of the device, communication with the network via the base station while the device is in the network coverage; and deactivating an access stratum (AS) layer of the device while the device is outside the network coverage.

Example 12 includes the method of any preceding examples, wherein the AS layer is activated while the device is in the network coverage, and wherein the AS layer notifies the NAS layer that the AS layer is activated.

Example 13 includes the method of any preceding examples, wherein the AS layer notifies the NAS layer that the AS layer is deactivated, and wherein the NAS layer forgoes performing a NAS procedure while the device is outside of the network coverage and the AS layer is deactivated.

Example 14 includes the method of any preceding examples, further comprising: determining, based on the path information, a value of a periodic search timer for a public land mobile network (PLMN) search; and performing the PLMN search based on the value of the periodic search timer.

Example 15 includes the method of claim 14, wherein the device prioritizes home PLMN (HPLMN) connectivity over visited PLMN (VPLM) connectivity.

Example 16 includes the method of any preceding examples 11-15, further comprising: determining, based on at least one of almanac information or ephemeris information, an access duration during which the device is expected to be in the network coverage, wherein the almanac information and the ephemeris information are included in the path information; connecting, during the access duration, to a visited PLMN (VPLMN); and performing, during the access duration, a PLMN search for a PLMN having a higher priority relative to the VPLMN.

Example 17 includes the method of any preceding examples 11-16, wherein the device remains in a sleep state of a discontinuous reception (DRX) cycle or a power save mode (PSM) while the device is outside the network coverage and enters a wake-up state while the device is in the network coverage.

Example 18 includes the method of example 17, wherein a timer of the DRX cycle or the PSM is set based on at least one of almanac information or ephemeris information, wherein the almanac information and the ephemeris information are included in the path information.

Example 19 includes the method of any preceding examples 11-18, further comprising: forgoing performing paging information monitoring while the device is outside the network coverage.

Example 20 includes the method of any preceding examples 11-19, further comprising: forgoing performing a NAS procedure while the device is outside the network coverage.

Example 21 includes the method of any preceding examples 11-20, further comprising: determining, based on at least one of almanac information or ephemeris information, an access duration during which the device is expected to be in the network coverage, wherein the almanac information and the ephemeris information are included in the path information; determining time duration for a NAS procedure based on the access duration; and performing, based on the time duration, the NAS procedure while the device is in the network coverage.

Example 22 includes the method of any preceding examples 11-21, wherein the path information includes almanac information and ephemeris information and is determined, along with a validity duration, from a non-volatile memory of the device or a universal subscriber identity module (USIM) of the device, and wherein the path information is used to determine that the device is in a network coverage based on the validity duration.

Example 23 includes the method of example 22, further comprising: receiving a system information block (SIB) broadcast that indicates the path information and whether the device is to read the path information from the SIB broadcast; and forgoing reading the path information from the SIB broadcast based on the validity duration and the SIB broadcast allowing the device not to read the path information from the SIB broadcast.

Example 24 includes the method of any preceding examples 11-23, wherein the path information includes first almanac information and first ephemeris information for a first public land mobile network (PLMN), and wherein the method further comprises: determining, for a second PLMN, second almanac information, second ephemeris information, and validity duration of the second almanac information and the second ephemeris, wherein the second almanac information, the second ephemeris, and the validity duration are pre-stored in a non-volatile memory of the device.

Example 25 is a method implemented by a base station of a network. The method comprising: sending, to a device, path information indicating a relative path between the device and the base station, wherein the path information indicates an access duration during which the device is expected to be in a network coverage provided by the base station; establishing, based on a non-access stratum (NAS) procedure, communication with the device during the access duration; and forgoing communication establishment with the device while the device is outside the network coverage.

Example 26 includes the method of example 25, further comprising forgoing sending paging information to the device while the device is outside the network coverage.

Example 27 includes the method of any preceding examples 25-26, wherein sending the path information comprises: sending almanac information indicating an orbit of a communications satellite that includes the base station and ephemeris information indicating positions of the communications satellite or a position and a velocity of the communications satellite.

Example 28 includes the method of any preceding examples 25-27, wherein sending the path information comprises: sending, during a previous access duration, first almanac information indicating an orbit of a communications satellite that includes the base station; and sending, during the access duration, second almanac information further indicating the orbit and ephemeris information indicating positions of the communications satellite or a position and a velocity of the communications satellite, wherein the first almanac information, the second almanac information, and the ephemeris information represent corresponding portions of the path information.

Example 29 includes the method of any preceding examples 25-28, wherein sending the path information comprises: sending at least one of almanac information or ephemeris information in a system information block (SIB) broadcast.

Example 30 includes the method of any preceding examples 25-29, wherein sending the path information comprises: sending at least one of almanac information or ephemeris information in NAS signaling during an attach procedure or a registration procedure.

Example 31 includes the method of any preceding examples 25-30, wherein at least one of a periodic registration timer, a tracking area update timer, a mobile reachable timer, or an implicit detach timer is configured by the network based on the access duration.

Example 32 includes a device comprising means to perform one or more elements of a method described in or related to any of the examples 1-24.

Example 33 includes one or more non-transitory computer-readable media comprising instructions to cause a device, upon execution of the instructions by one or more processors of the device, to perform one or more elements of a method described in or related to any of the examples 1-24.

Example 34 includes a device comprising logic, modules, or circuitry to perform one or more elements of a method described in or related to any of the examples 1-24.

Example 35 includes a device comprising: one or more processors and one or more computer-readable media comprising instructions that, when executed by the one or more processors, cause the one or more processors to perform one or more elements of a method described in or related to any of the examples 1-24.

Example 36 includes a system comprising means to perform one or more elements of a method described in or related to any of the examples 1-24.

Example 37 includes a network comprising means to perform one or more elements of a method described in or related to any of the examples 25-31.

Example 38 includes one or more non-transitory computer-readable media comprising instructions to cause a network, upon execution of the instructions by one or more processors of the network, to perform one or more elements of a method described in or related to any of the examples 25-31.

Example 39 includes a network comprising logic, modules, or circuitry to perform one or more elements of a method described in or related to any of the examples 25-31.

Example 40 includes a network comprising: one or more processors and one or more computer-readable media comprising instructions that, when executed by the one or more processors, cause the one or more processors to perform one or more elements of a method described in or related to any of the examples 25-31.

Example 41 includes a system comprising means to perform one or more elements of a method described in or related to any of the examples 25-31.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1.-25. (canceled)

26. An apparatus comprising:
processing circuitry configured to:
determine path information of a communications satellite of a network that provides discontinuous network coverage in one or more coverage areas;
determine, based on the path information, availability of a satellite coverage of the communications satellite;
establish, by using a non-access stratum (NAS) layer, communication with the network via the communications satellite during availability of the satellite coverage; and
deactivate an access stratum (AS) layer while the satellite coverage is unavailable; and
interface circuitry coupled with the processing circuitry to enable communication.

27. The apparatus of claim 26, wherein the processing circuitry is further configured to:
determine an access duration during which the availability is expected, wherein the path information is determined by at least receiving almanac information and ephemeris information from the communications satellite during the access duration or a previous access duration or from a different communications satellite during the previous access duration.

28. The apparatus of claim 26, wherein the processing circuitry is further configured to:
process first almanac information received in a previous access duration and indicating an orbit of the communications satellite, wherein the first almanac information represents a first portion of the path information;
determine, based on the first almanac information, an access duration during which the satellite coverage is available; and
process second almanac information received during the access duration and indicating the orbit of the communications satellite and ephemeris information that indicates positions of the communications satellite or a position and a velocity of the communications satellite, wherein the second almanac information and the ephemeris information represent a second portion of the path information, and wherein the access duration is further determined based on the second portion of the path information.

29. The apparatus of claim 26, wherein establishing the communication comprises performing a cell selection procedure, a public land mobile network (PLMN) selection procedure, an attach procedure, or a registration procedure based on determining that the availability of the satellite coverage.

30. The apparatus of claim 26, wherein the processing circuitry is further configured to:
determine that the network is a non-terrestrial network based on a system information block (SIB) acquisition;
determine that discontinuous coverage is expected based on the network being a non-terrestrial network and a device configuration, wherein the device configuration is at least one of a narrowband internet of things (NB-IOT) configuration, an enhanced machine type communication (eMTC) configuration, or a mobile IoT configuration; and
generate, for transmission to the network, a device identifier, the device identifier comprising a bit indicating satellite access and a set of bits indicating a selection of an IoT non-terrestrial network in one or more access technologies.

31. A method comprising:
determining path information indicating a relative path between a device and a base station of a network, the network providing discontinuous network coverage in one or more coverage areas;
determining, based on the path information, availability of a network coverage provided by the base station;
establishing, by using a non-access stratum (NAS) layer, communication with the network via the base station during the availability of the network coverage; and
deactivating an access stratum (AS) layer while the network coverage is unavailable.

32. The method of claim 31, wherein the AS layer is activated during the availability of the network coverage, and wherein the AS layer notifies the NAS layer that the AS layer is activated.

33. The method of claim 31, wherein the AS layer notifies the NAS layer that the AS layer is deactivated, and wherein the NAS layer forgoes performing a NAS procedure while the network coverage is unavailable and the AS layer is deactivated.

34. The method of claim 31, further comprising:
determining, based on the path information, a value of a periodic search timer for a public land mobile network (PLMN) search; and
performing the PLMN search based on the value of the periodic search timer.

35. The method of claim 31, further comprising:
determining, based on at least one of almanac information or ephemeris information, an access duration during which the availability of the network coverage is expected, wherein the almanac information and the ephemeris information are included in the path information;
connecting, during the access duration, to a visited PLMN (VPLMN); and
performing, during the access duration, a PLMN search for a PLMN having a higher priority relative to the VPLMN.

36. The method of claim 31, wherein a sleep state of a discontinuous reception (DRX) cycle or a power save mode (PSM) is maintained while the network coverage is unavailable, and wherein a wake-up state is entered while the network coverage is available.

37. The method of claim 6, further comprising:
forgoing performing paging information monitoring while the network coverage is unavailable.

38. The method of claim 31, further comprising:
forgoing performing a NAS procedure while the network coverage is unavailable.

39. The method of claim 31, further comprising:
determining, based on at least one of almanac information or ephemeris information, an access duration during the availability of the network coverage is expected, wherein the almanac information and the ephemeris information are included in the path information;
determining time duration for a NAS procedure based on the access duration; and
performing, based on the time duration, the NAS procedure during the availability of the network coverage.

40. The method of claim 31, wherein the path information includes almanac information and ephemeris information and is determined, along with a validity duration, from a non-volatile memory or a universal subscriber identity module (USIM), wherein the path information is used to determine that the availability of the network coverage based on the validity duration, and wherein the method further comprises:
receiving a system information block (SIB) broadcast that indicates the path information and whether to read the path information from the SIB broadcast; and
forgoing reading the path information from the SIB broadcast based on the validity duration and the SIB broadcast allowing not reading the path information from the SIB broadcast.

41. The method of claim 31, wherein the path information includes first almanac information and first ephemeris information for a first public land mobile network (PLMN), and wherein the method further comprises:
determining, for a second PLMN, second almanac information, second ephemeris information, and validity duration of the second almanac information and the second ephemeris, wherein the second almanac information, the second ephemeris, and the validity duration are pre-stored in a non-volatile memory.

42. A method comprising:
generating, for transmission to a device, path information indicating a relative path between the device and a base station, wherein the path information indicates an access duration during which the device is expected to be in a network coverage provided by the base station;
establishing, based on a non-access stratum (NAS) procedure, communication with the device during the access duration; and
forgoing communication establishment with the device while the device is outside the network coverage.

43. The method of claim 42, further comprising:
forgoing sending paging information to the device while the device is outside the network coverage.

44. The method of claim 42, wherein sending the path information comprises:
sending almanac information indicating an orbit of a communications satellite that includes the base station and ephemeris information indicating positions of the communications satellite or a position and a velocity of the communications satellite.

45. The method of claim 42, wherein sending the path information comprises:
sending, during a previous access duration, first almanac information indicating an orbit of a communications satellite that includes the base station; and
sending, during the access duration, second almanac information further indicating the orbit and ephemeris information indicating positions of the communications satellite or a position and a velocity of the communications satellite, wherein the first almanac information, the second almanac information, and the ephemeris information represent corresponding portions of the path information.
